(19) United States
(12) Patent Application Publication
(10) Pub. No.: US 2025/0344252 A1
(43) Pub. Date: Nov. 6, 2025

(54) GROUP-BASED NETWORK ACCESS

(71) Applicant: InterDigital Patent Holdings, Inc., Wilmington, DE (US)

(72) Inventors: Tejaswinee Lutchoomun, Montreal (CA); Jaya Rao, Montreal (CA); Senay Negusse, Montreal (CA); Ananth Kini, Conshohocken, PA (US); Ahmed Mostafa, Ottawa (CA)

(73) Assignee: InterDigital Patent Holdings, Inc., Wilmington, DE (US)

(21) Appl. No.: 18/860,756

(22) PCT Filed: Apr. 27, 2023
(86) PCT No.: PCT/US2023/020162

§ 371 Date: Oct. 28, 2024

Related U.S. Application Data
(60) Provisional application No. 63/335,421, filed on Apr. 27, 2022.
(60) Provisional application No. 63/395,600, filed on Aug. 5, 2022.
(60) Provisional application No. 63/421,688, filed on Nov. 2, 2022.

(51) Int. Cl. H04W 74/0833; H04W 76/15

(52) U.S. Cl. CPC H04W 74/0833; H04W 76/15

(57) ABSTRACT

Described herein are systems, methods, and instrumentalities associated with group-based network access such as an initial access to a network by a group of WTRUs. A description of a group-based initial access procedure is provided and messages/signals that may be transmitted or received by a WTRU during the group-based initial access procedure are also described, as well as ways for allocating resources in the group for sending the described messages/signals. The group-based initial access procedure may be performed based on detection of triggering events or conditions, and measurements may be performed to enable the group-based initial access procedure.

### CROSS-REFERENCE TO RELATED APPLICATIONS

This application claims the benefit of Provisional U.S. Patent Application No. 63/335,421, filed Apr. 27, 2022, Provisional U.S. Patent Application No. 63/395,600, filed Aug. 5, 2022, Provisional U.S. Patent Application No. 63/421,688, filed Nov. 2, 2022, the disclosures of which are incorporated herein by reference in their entireties.

### BACKGROUND

A wireless transmit/receive unit (WTRU) may gain access (e.g., initial access) to a network, for example, through a random access procedure. If each WTRU in a collaborative group handles the access procedure individually, the group (e.g., as a whole) may suffer from collisions, for example, due to additional delays that may be caused by contention resolution.

### SUMMARY

Disclosed herein are systems, methods, and instrumentalities associated with group-based network access, such as an initial access to a network by a group of WTRUs. A wireless transmit/receive unit (WTRU) (e.g., an anchor WTRU) may include a processor configured to transmit a first message to a network device, wherein the first message may include information regarding a group-based random access procedure associated with a group of WTRUs (e.g., the anchor WTRU may be a part of the group). The processor may be further configured to receive a response from the network device that may indicate one or more resources for the group-based random access procedure. The processor may be further configured to determine an allocation of the one or more resources indicated by the response to the group of WTRUs associated with the group-based random access procedure, and to send an indication to the group of WTRUs that may indicate the allocation of the one or more resources to the group of WTRUs, wherein the indication may be sent via one or more sidelink messages.

The processor of the WTRU may be configured to determine the allocation of the one or more resources to the group of WTRUs autonomously (e.g., without additional instructions from the network device). The processor of the WTRU may be further configured to determine that the one or more resources are insufficient to accommodate the group of WTRUs associated with the group-based random access procedure. Based on such a determination, the processor may be configured to allocate the one or more resources to the group of WTRUs based on respective transmission priorities or respective transmission time constraints associated with the group of WTRUs.

The one or more resources described herein may be associated with a contention-free access to the network device by the group of WTRUs. The response received from the network device may include information indicating how the one or more resources may be allocated to the group of WTRUs, and the processor of the WTRU may be configured to determine the allocation of the one or more resources to the group of WTRUs based on the information included in the response. The first message transmitted by the WTRU to the network device may include a random access preamble associated with the group-based random access procedure, and the first message may indicate a number of WTRUs associated with the group-based random access procedure.

The processor of the WTRU may be further configured to identify the group of WTRUs associated with the group-based random access procedure based on sidelink communications between the WTRU and the group of WTRUs, and the group-based random access procedure may be performed over an access network interface (e.g., a Uu interface) between the group of WTRUs and the network device. In embodiments, the processor of the WTRU may be further configured to transmit a second message to the network device, wherein the second message may indicate the allocation of the one or more resources to the group of WTRUs.

A member WTRU associated with the group-based random access procedure (e.g., the one or more other WTRUs described above) may be configured to transmit a message to an anchor WTRU via a sidelink, wherein the message may indicate a request by the WTRU to perform a random access procedure. The member WTRU may receive a response from the anchor WTRU, wherein the response may indicate one or more resources for the member WTRU to perform the random access procedure. The member WTRU may then perform the random access procedure with a network device using the one or more resources indicated by the anchor WTRU. In embodiments, the message transmitted by the member WTRU to the anchor WTRU may further indicate a transmission priority or a transmission time constraint associated with the member WTRU. In embodiments, the member WTRU may perform the random access procedure a contention-free manner using the one or more resources indicated by the anchor WTRU.

### BRIEF DESCRIPTION OF THE DRAWINGS

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 1C is a system diagram illustrating an example radio access network (RAN) and an example core network (CN) that may be used within the communications system illustrated in FIG. 1A according to an embodiment.

FIG. 1D is a system diagram illustrating a further example RAN and a further example CN that may be used within the communications system illustrated in FIG. 1A according to an embodiment.

FIG. 2A is a diagram illustrating an example of group-based initial access.

FIG. 2B is a diagram illustrating examples of what may be sent via Msg1 shown in FIG. 2A.

FIG. 2C is a diagram illustrating examples of what may be sent via Msg2 shown in FIG. 2A.

FIG. 3 is a diagram illustrating examples of random access types.

FIG. 4 is a diagram illustrating an example of a collaborative eXtended reality (XR) system.

### DETAILED DESCRIPTION

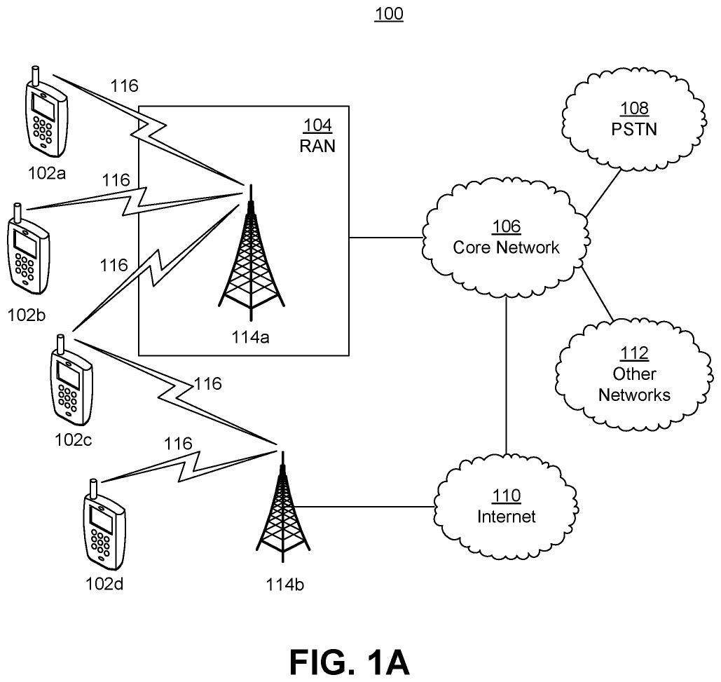

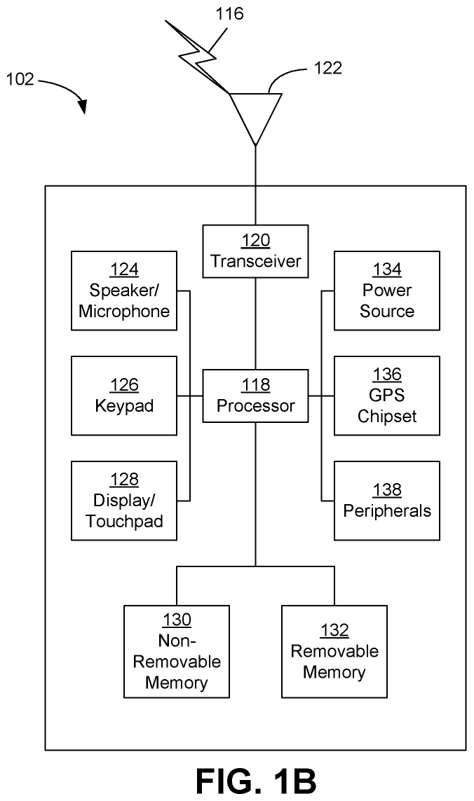

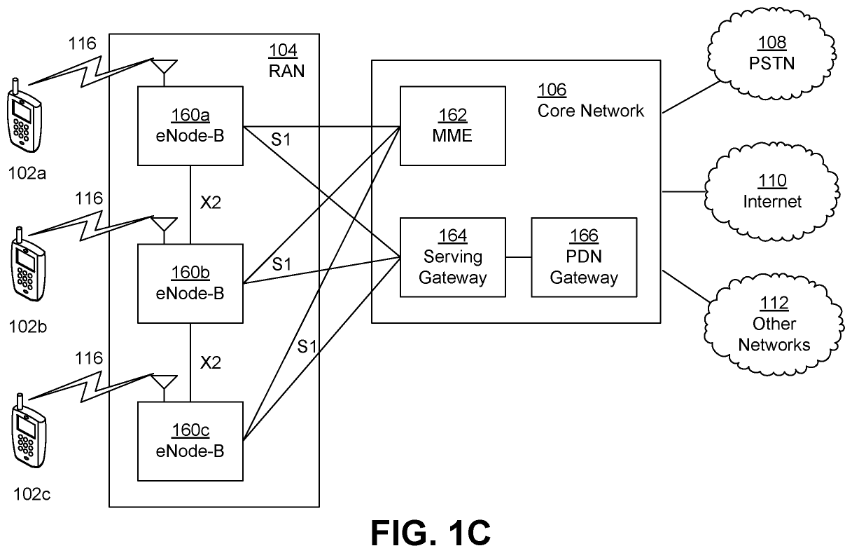

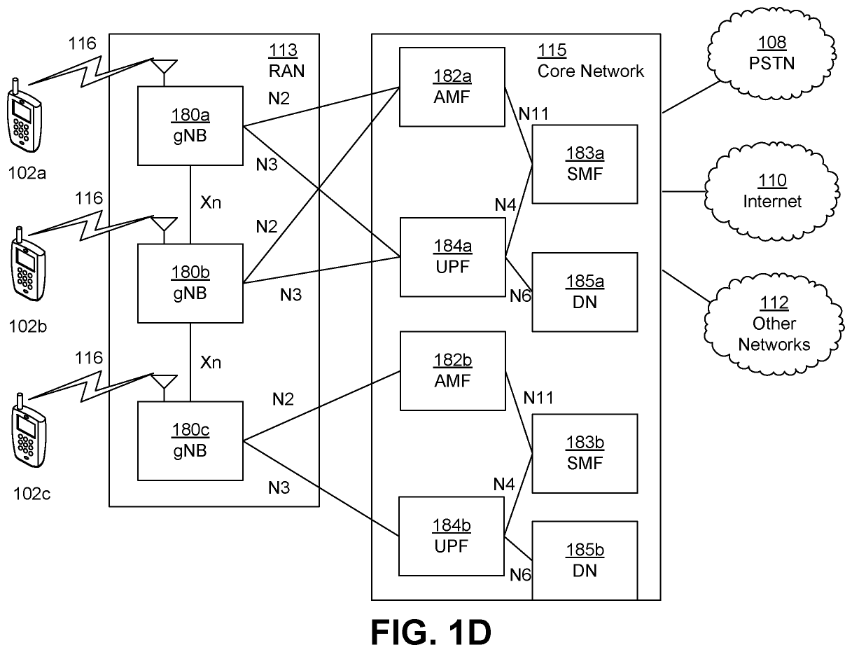

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c, and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B (eNB), a Home Node B, a Home eNode B, a gNode B (gNB), a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements is depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

Disclosed herein are systems, methods, and instrumentalities associated with group-based network access, such as an initial access to a network by a group of WTRUs. A wireless transmit/receive unit (WTRU) (e.g., an anchor WTRU of a WTRU group) may include a processor configured to transmit a first message to a network device, wherein the first message may include information regarding a group-based random access procedure associated with the WTRU and one or more other WTRUs (e.g., of the WTRU group). The processor may be further configured to receive a response from the network device that may indicate one or more resources for the group-based random access procedure. The processor may be further configured to determine an allocation of at least a portion of the one or more resources indicated by the response to the one or more other WTRUs associated with the group-based random access procedure, and to send an indication to the one or more other WTRUs that indicates the allocation of at least the portion of the one or more resources to the one or more other WTRUs, wherein the indication may be sent via one or more sidelink messages.

The processor of the WTRU may be configured to determine the allocation of at least the portion of the one or more resources to the one or more other WTRUs autonomously (e.g., without additional instructions from the network device). In embodiments, the one or more other WTRUs may be a subset of WTRUs associated with the group-based random access procedure, and the processor of the WTRU may determine that the one or more resources are insufficient to accommodate the WTRUs associated with the group-based random access procedure. Based on such a determination, the processor may be configured to allocate at least the portion of the one or more resources to the one or more other WTRUs based on transmission priorities associated with the one or more other WTRUs, or based on transmission time constraints associated with the one or more other WTRUs.

The one or more resources described herein may be associated with a contention-free access to the network device. In embodiments, the response received from the network device may further indicate how the one or more resources may be allocated to the one or more other WTRUs and the processor of the WTRU may be configured to determine the allocation of at least the portion of the one or more resources to the one or more other WTRUs based on the information included in the response. In embodiments, the first message transmitted by the WTRU to the network device may include a random access preamble associated with the group-based random access procedure, and the first message may indicate a number of WTRUs associated with the group-based random access procedure.

The processor of the WTRU may be further configured to identify the one or more other WTRUs associated with the group-based random access procedure based on sidelink communications between the WTRU and the one or more other WTRUs, and the group-based random access procedure may be performed over an access network interface (e.g., a Uu interface) between the one or more other WTRUs and the network device. In embodiments, the processor of the WTRU may be further configured to transmit a second message to the network device, wherein the second message may indicate the allocation of at least the portion of the one or more resources to the one or more other WTRUs.

A member WTRU associated with the group-based random access procedure (e.g., the one or more other WTRUs described above) may be configured to transmit a message to an anchor WTRU via a sidelink, wherein the message may indicate a request by the WTRU to perform a random access procedure. The member WTRU may receive a response from the anchor WTRU, wherein the response may indicate one or more resources for the member WTRU to perform the random access procedure. The member WTRU may then perform the random access procedure with a network device using the one or more resources indicated by the anchor WTRU. In embodiments, the message transmitted by the member WTRU to the anchor WTRU may further indicate a transmission priority or a transmission time constraint associated with the member WTRU. In embodiments, the member WTRU may perform the random access procedure a contention-free manner using the one or more resources indicated by the anchor WTRU.

As described herein, an anchor WTRU of a WTRU group such as a collaborative WTRU group formed based on an extended reality (XR) application may determine the number of WTRUs (e.g., member WTRUs including the anchor WTRU) in the group, for example, based on sidelink (SL) communications (e.g., data exchange) between the members, and/or further determine a time constraint (e.g., a max time constraint) for one or more (e.g., all) of the WTRUs in the group to perform an initial access to a network (e.g., the time constraint may be determined based on application layer information). The anchor WTRU may select RACH resources such as a RACH preamble based on system information (e.g., a system information block (SIB)) received by the anchor WTRU and may indicate (e.g., explicitly or implicitly) to a network device a request for a group-based initial access. The indication of the request may be sent, for example, in Msg1 associated with random access and/or based on the selected resources. The anchor WTRU may (e.g., based on a response received from the network device) determine an allocation of one or more RACH resources (e.g., one or more preambles, one or more random access occasions (ROs), etc.) to the WTRUs associated with the random access request (e.g., to one or more member WTRUs of the group). The anchor WTRU may determine the resource allocation, for example, based on group-based RACH resources (e.g., assigned by the network device in a random access response such as in Msg2), based on application layer information, and/or in a contention-free manner. As will be described in more details below, the resource allocation to the member WTRUs may be performed by the anchor WTRU autonomously (e.g., the anchor WTRU may determine, on its own, which resource granted by the network goes to which member WTRU, and may inform the member WTRU about the determination). The resource allocation may also be indicated in the response received from the network device (e.g., the network device may not only provide the resources but also indicate which resource goes to which member WTRU, and the anchor WTRU may inform the member WTRU about the indicated allocation).

In embodiments, a WTRU (e.g., the anchor WTRU described herein) may receive from a higher layer message (e.g., via RRC signaling), an application, and/or a member WTRU (e.g., via a sidelink (SL) message) information regarding a time duration (e.g., a maximum time duration) for a WTRU group (e.g., members of the WTRU group) to establish connectivity with a network (e.g., initial access), a priority (e.g., a transmission priority) of a (e.g., each) member WTRU, a transmission time constrain of a (e.g., each) member WTRU, an NAS ID of a (e.g., each) member WTRU, etc. The WTRU (e.g., the anchor WTRU described herein) may receive (e.g., in a SIB such as SIB 1 or an XR-specific SIB) RACH preambles (e.g., RACH preamble IDs) and/or association information between RACH preambles and the number of WTRUs in the WTRU group. The WTRU may send (e.g., in Msg1) a RACH preamble corresponding to the number of WTRUs in the WTRU group (e.g., n WTRUs). The WTRU may receive (e.g., in a response such as Msg2) a reservation indication that may indicate RACH resources (e.g., contention free RACH preambles, m ROs, etc.) for a number of (e.g., m) WTRUs in the WTRU group (e.g., m may be less than or equal to n). The WTRU may receive a timing advance (TA), a UL grant (e.g., for this WTRU or another WTRU), a group temporary cell RNTI (TC-RNTI), etc., in the response.

The WTRU (e.g., the anchor WTRU described herein) may determine an allocation of RACH resources (e.g., at least a portion of the RACH resources) to one or more member WTRUs (e.g., all n WTRUs including the anchor WTRU) in the WTRU group based on one or more of a time constraint or duration for the WTRU group to establish connectivity to a network, based on the priority (e.g., transmission priority) of a member WTRU, based on a transmission time constraint associated with a member WTRU, and/or based on a resource assignment or reservation indication provided by the network for the WTRUs. The WTRU (e.g., the anchor WTRU) may inform the one or more WTRUs about the resource allocation (e.g., a portion of the resources may be allocated for the anchor WTRU itself). For example, the WTRU may send information regarding the determined RACH resource allocation (e.g., allocation of preambles, ROs, etc.), corresponding NAS ID(s), and/or a group TC-RNTIs to the one or more member WTRUs (e.g., via unicast and/or multicast messages over an SL interface).

The WTRU (e.g., the anchor WTRU described herein) may send to the network device (e.g., in Msg3 associated with random access) a confirmation of the RACH resource assignment or allocation to the one or more member WTRUs. The confirmation message may, for example, indicate whether the RACH resource assignment or allocation is successful, an anchor WTRU NAS ID, a group NAS ID, and/or a group RRC request (e.g., an RRC setup request for one or more WTRUs in the WTRU group).

The WTRU (e.g., the anchor WTRU described herein) may receive (e.g., in Msg4 associated with random access) a status report from the network device indicating whether an initial access by one or more (e.g., all) WTRUs in the WTRU group is successful. If the status report indicates a group NAS ID, the WTRU (e.g., the anchor WTRU described herein) may assume that initial access by the member WTRUs (e.g., which may include the anchor WTRU) is successful. If the status report indicates NAS ID(s) of successful member WTRU(s) (e.g., which may include the anchor WTRU), and/or validity information indicating the validity of previously received RACH resources (e.g., in Msg 2), the WTRU (e.g., the anchor WTRU) may assume that initial access by at least one member WTRU (e.g., which may be the anchor WTRU) is unsuccessful. The WTRU may determine the member WTRUs that are unsuccessful with the initial access and/or the corresponding RACH resources for re-transmissions (e.g., of initial access messages) based on the status report and/or the validity information. The WTRU may notify (e.g., via an SL interface) the unsuccessful member WTRUs about the determined RACH resources for re-transmission (e.g., of MsgA or Msg1).

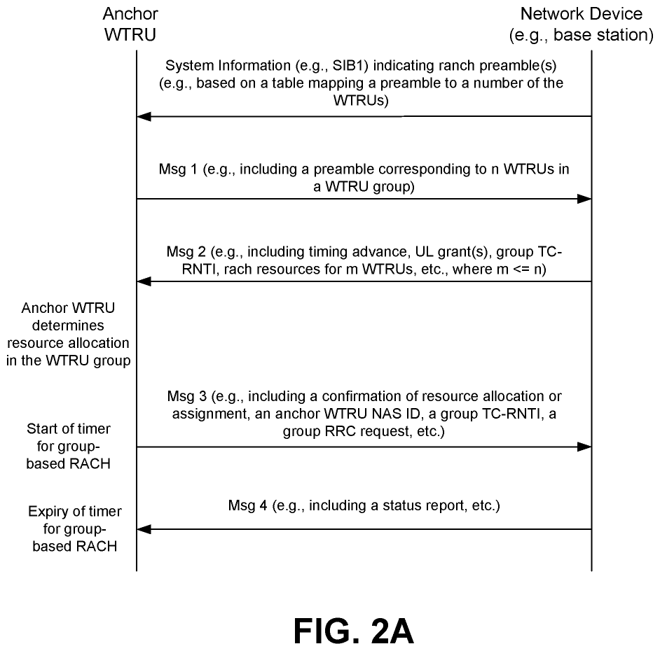

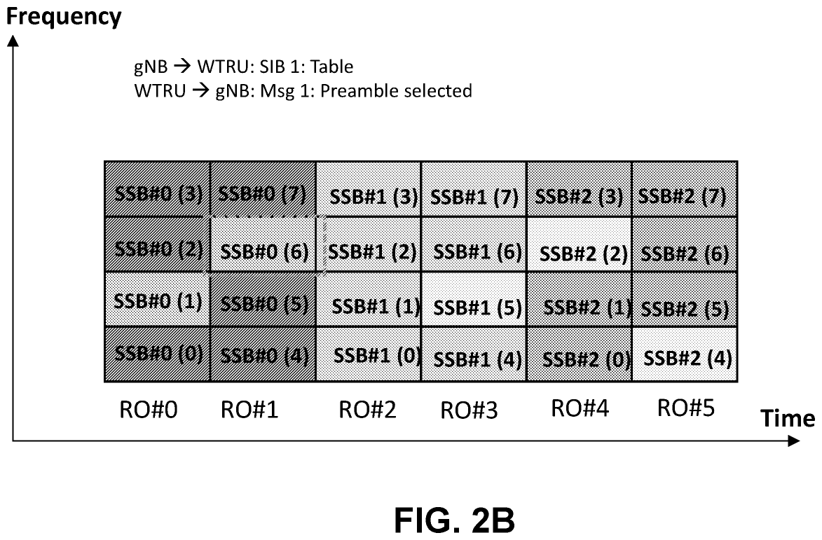

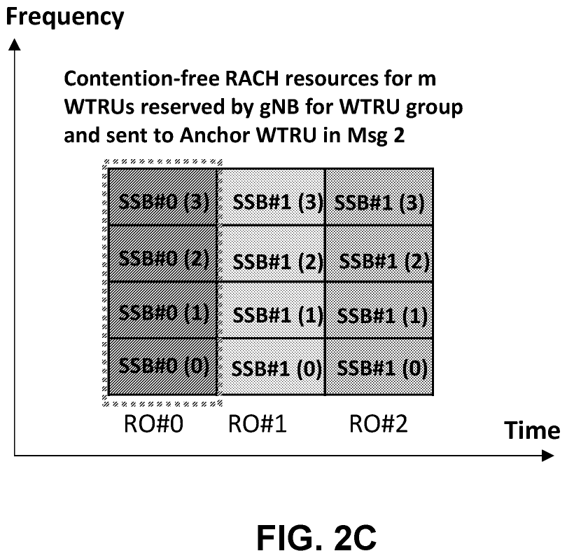

FIGS. 2A-2C illustrate one or more of the techniques described herein. FIG. 2A illustrates an example of a group-based initial access procedure, FIG. 2B illustrates what may be included in Msg1 shown in FIG. 2A, and FIG. 2C illustrates what may be included in Msg2 shown in FIG. 2A.

A member WTRU may send to an anchor WTRU assistance information to assist with a group-based initial access. The member WTRU may use group-based contention-free RACH resources (e.g., indicated by the anchor WTRU) to perform the initial access. The member WTRU may, for example, send to the anchor WTRU one or more of an NAS ID or a request to assist the initial access (e.g., via a Uu link between the member WTRU and a network device). The member WTRU may receive from the anchor WTRU (e.g., via an SL message) one or more RACH resources (e.g., one or more contention-free RACH preambles, one or more ROs, etc.), a TA, and/or a group TC-RNTI to use for the initial access. The member WTRU may send (e.g., in MsgA or Msg 1), a RACH message (e.g., including a RACH preamble) using the contention-free resources received from the anchor WTRU. An MsgA or Msg 1 as described herein may include a preamble and/or an NAS ID (e.g., a collaborative WTRU may encode or scramble a preamble with an NAS ID). The member WTRU (or the anchor WTRU) may start a timer associated with the group-based initial access. The member WTRU (or the anchor WTRU) may receive (e.g., in MsgB) an NAS ID. The member WTRU (or the anchor WTRU) may use a group TC-RNTI and/or a C-RNTI in subsequent initial access messages. The member WTRU may send an acknowledgment (ACK) indication to the anchor WTRU indicating a successful initial access.

At the expiry of a timer (e.g., the timer shown in FIG. 2A) associated with the group-based initial access procedure, if the member WTRU does not receive (e.g., in MsgB) an NAS ID or does not receive a RACH response (e.g., MsgB) at all, the member WTRU may send a negative-acknowledgment (NACK) indication to the anchor WTRU indicating an unsuccessful initial access and the member WTRU may request assistance information (e.g., from the anchor WTRU) for re-transmission of a RACH message (e.g., MsgA).

If the member WTRU receives assistance information (e.g., from the anchor WTRU), the member WTRU may re-send a RACH message (e.g., MsgA) using a preamble (e.g., indicated by the anchor WTRU). If the member WTRU does not receive assistance information (e.g., from the anchor WTRU), the member WTRU may send another RACH message (e.g., Msg1) and may revert back to a legacy RACH procedure.

The term eXtended Reality (XR) may be used herein to refer to different types of immersive experiences including, for example, Virtual Reality (VR), Augmented Reality (AR), Mixed Reality (MR), and/or an interpolated reality based on these types of immersive experiences. Virtual Reality (VR) may include a rendered version of a delivered visual and/or audio scene. The rendering may mimic the visual (e.g., stereoscopic three-dimensional (3D)) and/or audio sensory stimuli of the real world to observers or users as they move within the limits defined by an application. Augmented Reality (AR) may provide a user with additional information or artificially generated items or content overlaid upon the user's current environment. Mixed Reality (MR) may include an advanced form of AR where some virtual elements may be inserted into a physical scene with the intent to provide the illusion that these elements are part of the real scene. XR may include one or more real-and-virtual combined environments and/or human-machine interactions generated by computer technology and/or wearables.

The notion of immersion in the context of XR applications or services may refer to the sense of being surrounded by a virtual environment as well as the feeling of being physically and spatially located in the virtual environment. The levels of virtuality may range from partial sensory inputs to fully immersive multi-sensory inputs leading to a virtual reality practically indiscernible from actual reality.

A WTRU as described herein may include an XR device that may be capable of offering various degrees of spatial tracking. Such an XR device may be equipped with various sensors to enable spatial tracking. The sensors may include, for example, monocular cameras, stereo cameras, depth cameras, radio beacons, GPS devices, inertial sensors, etc. Spatial tracking may be performed at different levels, e.g., with 3 Degrees of Freedom (DoF) (e.g., rotational motion along X, Y and Z axis), or 6 DoF (e.g., rotational and/or translational motion along X, Y and Z axis). Spatial tracking may result in an interaction to experience some form of virtual content. A user may act in and/or interact with one or more components within extended reality. For example, the actions and/or interactions may involve movements, gestures, eye tracking, etc. Spatial tracking may enable immersive XR experience. For example, some form of head and/or motion tracking may ensure that simulated visual and audio components from a user perspective be updated to be consistent with the user's movements. Imprecise and/or delayed spatial tracking may lead to sensation of discomfort and/or motion sickness for a user.

A WTRU as described herein may include an XR device or XR node that may be implemented in a variety of form factors. A WTRU as described herein (e.g., an XR WTRU) may include, but may not be limited to, one or more of the following: one or more Head Mounted Displays (HMD), one or more pairs of optical see-through glasses and camera see-through HMDs for AR and MR, one or more mobile devices with positional tracking capabilities and a camera, one or more wearables devices, etc. Different types of XR WTRUs may be envisioned, for example, based on XR device functions (e.g., as a display, as a camera, as a sensor, for sensor processing, for wireless connectivity, for XR or media processing, as a power supply, etc.) to be provided by the WTRUs devices, wearables, actuators, controllers and/or accessories described herein. One or more WTRUs such as one or more XR devices or XR nodes may be grouped into a collaborative group, for example, to support an XR application, an XR experience, an XR service, etc.

The term “initial access” and the term “random access” may be used interchangeably herein to refer to the one or more operations or procedures associated with establishing connectivity between a WTRU and a network. A random access procedure may be triggered for a WTRU by one or more of the following events: an initial access from an RRC IDLE state, an RRC connection re-establishment procedure, downlink (DL) or uplink (UL) data arrival in an RRC_CONNECTED state (e.g., if a UL synchronization status is “non-synchronized”), UL data arrival in a RRC_CONNECTED state (e.g., if no PUCCH resources for a scheduling request (SR) are available), an SR failure, an RRC request upon synchronous reconfiguration (e.g., handover), an RRC connection resume procedure from an RRC_INACTIVE state, establishment of time alignment for a secondary timing advance group (TAG), a request for system information (SI), beam failure recovery, consistent UL listen-before-talk (LBT) failures on a cell such as a special cell (SpCell), etc.

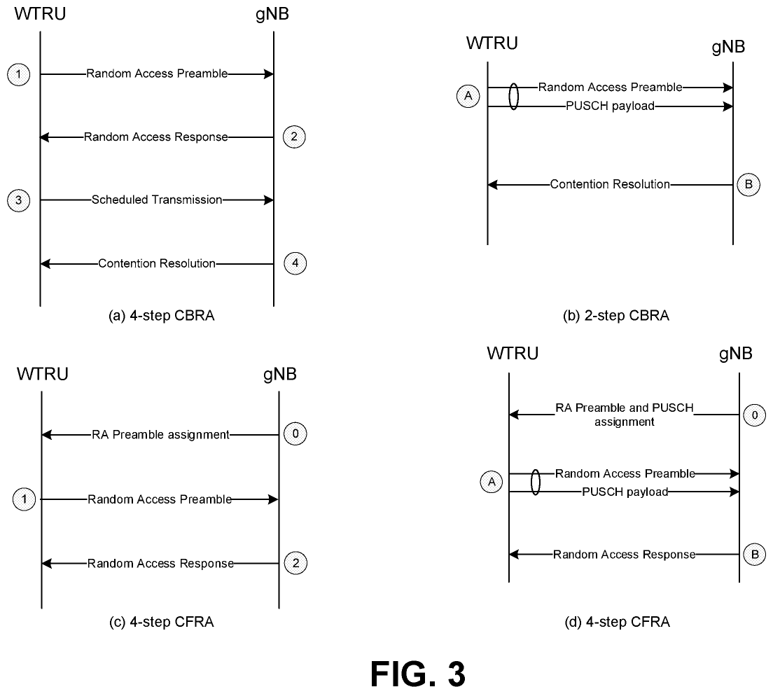

Multiple (e.g., two or more) types of random access (RA) procedures may be supported including, for example, a 4-step RA type with message 1 (Msg1 or Msg 1), message 2 (Msg2 or Msg 2), message 3 (Msg3 or Msg 3), and message 4 (Msg4 or Msg 4), and a 2-step RA type with message A (MsgA or Msg A) and message B (MsgB or Msg B). One or more types of RA procedures may support contention-based random access (CBRA) and/or contention-free random access (CFRA), for example, as shown in FIG. 3, which illustrates examples of different types of initial access. Additional messages may also be transmitted and/or received during and/or around an RA procedure. For example, a WTRU may transmit a Msg 5 described herein to a network device (e.g., a base station) in response to receiving a Msg 4 from the network device. The WTRU may include various information in Msg 5, such as, for example, a public land mobile network (PLMN) ID and/or other dedicated NAS info.

A WTRU may select a type of random access at the initiation of a random access procedure, for example, based on network configuration information. For example, if CFRA resources are not configured, a reference signal receive power (RSRP) threshold may be used by the WTRU to select between the 2-step RA type and a 4-step RA type; if CFRA resources for the 4-step RA type are configured, the WTRU may perform a 4-step RA procedure; if CFRA resources for the 2-step RA type are configured, the WTRU may perform a 2-step RA procedure.

A network may or may not configure CFRA resources for the 4-step and 2-step RA types at the same time for a bandwidth part (BWP). A 2-step CFRA may be supported in a handover situation (e.g., only for the handover situation).

Msg1 of the 4-step RA type may include a preamble transmitted on a physical random access channel (PRACH). A WTRU may monitor (e.g., after Msg1 transmission) for a response from a network within a configured window (e.g., a configured time window). For CFRA, a dedicated preamble for Msg1 transmission may be assigned by the network and the WTRU may end (e.g., upon receiving a random access response from the network) the random access procedure, for example, as shown in FIG. 3-(c). For CBRA, the WTRU may send (e.g., upon reception of a random access response) message 3 (Msg3) using a UL grant scheduled in the response and the WTRU may monitor for contention resolution, for example, as shown in FIG. 3-(a). If the contention resolution is not successful after Msg3 (re)transmission(s), the WTRU may go back to Msg1 transmission.

The MsgA of the 2-step RA type may include a preamble transmitted on the PRACH and/or a payload on a physical uplink shared channel (PUSCH). A WTRU may monitor (e.g., after MsgA transmission) for a response from a network within a configured window (e.g., a configured time window). For CFRA, a dedicated preamble and/or a PUSCH resource may be configured for MsgA transmission and the WTRU may (e.g., upon receiving a network response) end the random access procedure, for example, as shown in FIG. 3-(d). For CBRA, if contention resolution is successful upon receiving a network response, the WTRU may end a random access procedure, for example, as shown in FIG. 3-(b). If a fallback indication is received in message B (MsgB), the WTRU may perform a Msg3 transmission using a UL grant scheduled in the fallback indication and the WTRU may monitor for contention resolution. If the contention resolution is not successful after Msg3 (re)transmission(s), the WTRU may go back to MsgA transmission. If the random access procedure with the 2-step RA type is not completed after a number of MsgA transmissions, the WTRU may be configured to switch to CBRA with the 4-step RA type.

In examples (e.g., for random access in a cell configured with a supplemental uplink (SUL)), a network may signal (e.g., explicitly) which carrier may be used (e.g., a UL carrier or a SUL carrier). If no such signal is received from the network, a WTRU may select a SUL carrier if (e.g., only if) the measured quality of the DL is lower than a threshold (e.g., a broadcasted threshold). The WTRU may perform carrier selection before selecting between the 2-step RA type and the 4-step RA type. The threshold (e.g., an RSRP threshold) for selecting between the 2-step and 4-step RA types may be configured (e.g., separately) for a UL and a SUL. Once started, one or more (e.g., all) uplink transmissions associated with a random access procedure may remain on a selected carrier.

In examples (e.g., if carrier aggregation (CA) is configured), a random access procedure with the 2-step RA type may be performed on (e.g., only on) a primary cell (PCell) while contention resolution may be cross-scheduled by the PCell. In examples (e.g., when CA is configured), for a random access procedure of the 4-step RA type, the first three steps of a CBRA procedure may occur (e.g., always occur) on the PCell while contention resolution (e.g., as step 4) may be cross-scheduled by the PCell. The first three steps of a 4-step CFRA procedure that may have started on the PCell may remain on the PCell. A CFRA procedure on a SCell may be initiated (e.g., may only be initiated) by a base station (e.g., a gNB), for example, to establish timing advance for a secondary TAG. For example, the procedure may be initiated by the gNB with a PDCCH order (e.g., as step 0) that may be sent on a scheduling cell of an activated SCell of the secondary TAG. A preamble transmission (e.g., in step 1) may take place on an indicated SCell, and a random access response (e.g., in step 2) may take place on the PCell.

If each WTRU in a collaborative group handles the random access procedure individually, the random access process for the collaborative group of WTRUs may suffer, for example, from random access collisions. Such random access related contentions may occur, for example, in an Internet of things (IoT) use case where accesses by a large number of IoT devices may be supported. These IoT devices (e.g., the number of which may be massive) may or may not have strict latency requirements to meet. For other devices such as XR devices, there may be stringent latency requirements (e.g., imposed by XR applications) and random access collisions may result in failures to meet the stringent latency requirements, for example, due to additional delays that may be caused by RA contention resolution. Having an anchor WTRU in such a collaborative WTRU group (e.g., which may comprise multiple XR devices) may enhance the efficiency of a random access procedure, for example, by allowing the anchor WTRU to coordinate the process or handle it at least partially on behalf of one or more other WTRUs (e.g., and the anchor WTRU itself). An efficient initial access process for a group of WTRUs may mitigate random access contention and/or reduce the initial access latency in the group. As a result, satisfactory quality of experience (QoE) may be achieved for users, for example, in XR applications (e.g., by meeting the latency requirements of the XR applications for a collaborative group of XR WTRUs coherently to provide immersive XR experience to the users).

Challenge to be addressed with respect to an initial access to a network may include how to support efficient initial access for a group of WTRUs (e.g., a collaborative WTRU group) so as to enable the WTRUs to perform the initial access within stringent latency bounds, whether and/or how an anchor WTRU may be used to ensure that other WTRUs (e.g., members of the WTRU group including the anchor WTRU itself) may be able to perform a random access procedure such as a 2-step RACH procedure with a minimized probability of contention, how to perform an efficient random access procedure for a collaborative group of WTRUs (e.g., XR devices) within a stringent time constraint and to mitigate contentions among the WTRUs, how to support (e.g., guarantee) group-based initial access within stringent latency bounds, how to enable the collaborative WTRUs to perform a contention-free (e.g., substantially contention-free) RACH procedure within a stringent time window, etc.

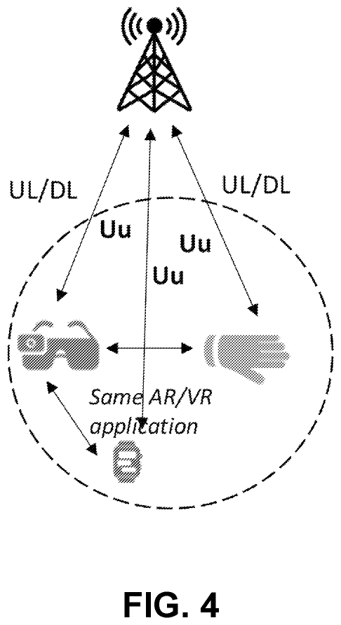

FIG. 4 illustrates an example of a collaborative XR system. In the embodiments described herein, a network may refer to or include any of a base station (e.g., gNB, transmission reception point (TRP), RAN node, access node, etc.), a core network function (e.g., AMF), and/or an application function (e.g., edge server function, remote server function, etc.), for example. In the embodiments described herein, flows may correspond to or include any of QoS flows or data flows (e.g., flow of data comprising one or more PDUs or ADUs, which may be associated with one or more QoS requirements related to latency, data rate, reliability, etc.). Different flows (e.g., originating from a common application/experience source and/or intended for a common destination device/WTRU or a group of associated devices/WTRUs) may be referred to as associated flows or correlated flows. In the embodiments described herein, a forwarding configuration may correspond to or include configuration information associated with any of the following: radio bearers (e.g., data radio bearers (DRBs) and/or signaling radio bearers (SRBs)), logical channels (LCHs), logical channel groups (LCGs), configuration parameters in the individual layers of an AS protocol stack (e.g., a service data adaptation protocol (SDAP), a packet data convergence protocol (PDCP), an RLC protocol layer, a MAC protocol layer, a PHY protocol layer, and/or other protocol layers), parameters associated with logical channel prioritization (LCP) (e.g., priority, prioritized bit rate (PBR), bucket size duration (BSD), etc.), BWPs, carriers, radio links or interfaces (e.g., Uu links, SLs, etc.), and/or radio resources (e.g., a set of one or more frequency/time/spatial resources such as timeslots, subcarriers, or beams, radio resources associated with configurated grants, dynamic grants and/or any other resource grants or grant free resources, etc.).

In the embodiments described herein, a “collaborative XR WTRU” or “collaborative WTRU group” may refer to, but may not be limited to, one or more of the following concepts and definitions. XR applications and/or services may be support, whereby one or more WTRUs may perform at least one XR related action resulting in XR experiences being provided to a user. These experiences may include, for example, enabling a sensation, where the user may perceive a full or partial immersion in different real and/or virtual environments, providing the user with the ability to interact with real and/or virtual objects including avatars, etc. A WTRU may include one or more of an independent (e.g., stand-alone) device or node (e.g., an XR device, a pair of XR glasses, a smart watch, a wearable device, etc.), a non-stand-alone device or node (e.g., a device associated with WTRUs, sensors, wearable devices, haptics gloves, etc.), a device or node controlled by a network (e.g., by a network operator), a device or node that may not be directly associated with and/or connected to a network (e.g., to a gNB), but may be a candidate given certain parameters (e.g.,, such as field of view (FoV) metadata including the size, dimension, quality, etc. of the FoV, pose information, etc.), a stationary mobile device or node, a static device or node, a moving or mobile device or node, and/or the like. In the embodiments described herein, terms corresponding to any of a WTRU, a node, or a device may be used interchangeably and may refer to any type of devices described herein.

A collaborative group may include one or more WTRUs, wherein a WTRU may be designated as an anchor WTRU and one or more other WTRUs may be designated as collaborative WTRUs or member WTRUs (e.g., the anchor WTUR may also perform the functions of a member WTRU). In examples, an anchor WTRU (e.g., in the context of collaborative XR) may refer to a WTRU configured to perform one or more of the following functions: hosting application function (e.g., an XR application) from which a request for an XR action (e.g., any XR action) may be received; receiving a request for an XR action from an application function located in a network (e.g., on an edge server or a remote server); initiating a discovery procedure for determining other WTRUs (e.g., devices or nodes in the proximity of the anchor WTRU) that may be involved in performing an (e.g., any) XR action in a collaborative group; establishing connectivity and/or sessions (e.g., XR sessions, PDU sessions, application sessions, etc.) by sending and/or receiving requests for session establishment and/or operating as a primary anchor point for communicating with an access network (e.g., RAN) function or node (e.g., such as a gNB), a core network function or node, and/or an application function. These operations may include, for example, sending and/or receiving session related messages (e.g., capability transfer, assistance info transfer, configuration transfer, measurement information, XR action status information, session activation/deactivation, session release, etc.). When supporting a connection to a network, an interface between the anchor WTRU (or a member WTRU) and the network (e.g., a gNB) may be referred to as a Uu link (e.g., a primary Uu link).

The terms “collaborative WTRU” or “member WTRU” may be used interchangeably herein, for example, in the context of collaborative XR, and may refer to a (e.g., any) WTRU involved in performing one or more of the following: initiating a discovery procedure and/or receiving requests for making a WTRU discoverable (e.g., via a sidelink or through a network) for performing an (e.g., any) XR action (e.g., when supporting a connection to a network, an interface between a collaborative WTRU and the network such as a gNB may be referred to as a secondary Uu link); sending information related to XR actions (e.g., pose information, FoV parameters including the direction and/or width of a FoV, other FoV metadata, data containing captured or mapped FoV contents, media or video frames, assistance information, status information, etc.) directly to a network (e.g., a gNB, a CN function, an application function, etc.) and/or indirectly to an anchor WTRU; receiving information (e.g., RRC configuration info, application configuration information, etc.) that may be used for determining an (e.g., any) XR action and/or an anchor WTRU; sending XR action related messages or reports to an anchor WTRU and/or a network (e.g., the messages or reports may include pose and/or FoV measurements or estimates) over network and/or sidelink interfaces (e.g., over a sidelink, a Bluetooth connection, a WiFi connection, etc.). A collaborative WTRU may be associated with multiple collaborative groups and anchor WTRUs.

When referred to herein, XR experiences may include the overall experience of an end user that may result from coordinated transmission and/or reception of data to/from an end device in a reliable and timely manner. Terminologies related to “multi-modality” may refer to an (e.g., any) association between multiple flows and/or multiple WTRUs. The flows and/or WTRUs may be associated with a collaborative WTRU group and/or with supporting an application or service common to one or more WTRUs.

“Anchor WTRU” or “collaborative WTRU” are non-limiting examples of terminologies that may be used in association with the embodiments described herein. Other terminologies that may be used when referring to an anchor WTRU may include “central WTRU,” “primary WTRU,” “main WTRU,” “initiating WTRU,” etc. Other terminologies that may be used when referring to a collaborative WTRU may include “member WTRU,” “assisting WTRU,” “supporting WTRU,” “secondary WTRU,” etc. The entities or objects described herein, including a collaborative group, an anchor WTRU, a collaborative WTRU, and/or XR actions may be associated with respective (e.g., different) identifiers (IDs) such as collaborative group IDs, per-group anchor WTRU IDs, per-group collaborative WTRU IDs, XR action IDs, etc. The respective identifiers or IDs associated with collaborative XRs may be assigned or configured, for example, by any of a WTRU, a network, or an application function. When referred to herein, tertiary WTRUs may be a type of WTRUs that may be associated with a role in a collaborative group and functional capabilities (e.g., similar to secondary WTRUs). A tertiary WTRU may be involved in an XR action for a shorter duration and/or a smaller partial task. A tertiary WTRU may be configured based on partial configuration information. A tertiary WTRU may take less time and/or less overhead to complete or perform an XR action.

Identifiers may be used to associate WTRUs in a collaborative WTRU group (e.g., which may also be referred to herein as a WTRU group). An anchor WTRU and a collaborative WTRU (e.g., which may also be referred to herein as a member WTRU) may be associated, for example, at a level that may vary from one XR experience to another, and/or within the same XR experience. The association between WTRUs in a collaborative WTRU group may be initiated, for example, by an application (e.g., following a request for the application to offer an XR experience). The association between WTRUs in a collaborative WTRU group may permeate through or translate to the other layers in a communication framework (e.g., NAS, RRC, SDAP, PDCP, RLC, MAC, PHY or any layer of an AS protocol stack).

An initial ID associated with an application may be retained through multiple layers, or there may be different IDs generated in different layers and an association may be made between the corresponding ID(s) within a (e.g., each) layer. The IDs may remain the same through an XR experience or from one XR session to another XR session. The IDs may change from one XR experience to another, or from one XR session to another XR session. Management and storage of IDs between WTRUs in a collaborative WTRU group may be performed by a CN, a base station, an application, and/or WTRUs involved in an XR experience.

Service IDs and XR action IDs may be matched. For example, an anchor WTRU may send one or more of the following IDs to a member WTRU: an application/service/session ID, a WTRU ID, a collaborative group ID, an XR action ID (e.g., for identifying an XR action supported by the WTRU and/or requested to be performed by other WTRUs), and/or the like. A member WTRU may send an indication in response to detecting that a service ID or XR action ID (e.g., in a discovery, solicitation, or indication message received from an anchor WTRU) matches a service ID or XR action ID pre-configured for or available at the member WTRU. IDs associated with one or more WTRUs (e.g., WTRU IDs, C-RNTIs, etc.) in a collaborative WTRU group and/or an ID associated with the collaborative WTRU group (e.g., a group RNTI) may be used in a (e.g., any) user plane (UP) or control plane (CP) procedure (e.g., a scheduling procedure). For examples, the IDs may be used when sending an RRC message, an SR/BSR, UCI, an UL MAC CE, a PUCCH transmission, a PUSCH transmission, WTRU assistance data, etc., and/or when receiving RRC signaling or an RRC message, resource grants, configured grants, DCI, a DL MAC CE, a PDCCH transmission, a PDSCH transmission, etc.

A WTRU may indicate its matching capabilities. For example, a collaborative WTRU may send an indication upon determining that one or more capabilities (e.g., an XR capability and/or a connectivity capability) currently supported by or within the WTRU's capabilities to support match those indicated by an anchor WTRU (e.g., in a discovery, solicitation, or indication message).

WTRU group-based initial access may be supported. In embodiments, multiple WTRUs in a collaborative WTRU group (e.g., including at least an anchor WTRU and a member WTRU) may coordinate within the group to perform an initial access procedure on a group basis. When referred to herein, a group-based initial access may refer to any procedures and/or functionalities performed by an anchor WTRU and/or one or more member WTRUs to accomplish an initial access. Such procedures and/or functionalities may include transmission and/or reception of an (e.g., any) initial access message (e.g., Msg1, Msg2, etc.), and/or determination of any of the corresponding actions (e.g., performed individually or on a group-basis) by one or more WTRUs during an initial access procedure.

An initial access signal as described herein may include any of the following: one or more RACH preambles, one or more sequences, and/or one or more partitions and/or resources that may be transmitted by a WTRU during a time occasion (e.g., a RACH occasion); one or more UL resource grants or channels for sending an indication, message, or flag (e.g., a request for group initial access) that may be associated with performing a group-based initial access procedure; etc.

While performing a group-based initial access, a WTRU (e.g., an anchor WTRU and/or a member WTRU) may transmit or receive an indication, a signal (e.g., control and/or data signals), a message, and/or a configuration via a combination of one or more of the following: broadcast signaling, RRC signaling, a MAC CE, an initial access message, a L1 channel transmission, etc. For example, the WTRU may access or acquire information for performing a group-based initial access via any of an SIB, a position SIB (posSIB), and/or an SSB. The WTRU may transmit and/or receive a request message, a response message, and/or a configuration message associated with positioning and/or initial access via an RRC message. The WTRU may transmit and/or receive a request message, a response message, a configuration message, and/or an activation/deactivation indication associated with positioning and/or initial access in one or more MAC CEs. In the UL, MAC CEs (e.g., carrying a request or response message) may be multiplexed in a PUSCH when transmitting Msg3 or MsgA, for example. In the DL, MAC CEs may be multiplexed in a PDSCH when receiving Msg2, Msg4, or Msg B, for example. The initial access messages described herein may include Msg1, Msg2, Msg3, Msg4, Msg5, MsgA, and/or MsgB. The L1 channel transmissions described herein may include a PUCCH transmission, a PUSCH transmission, a PDCCH transmission, and/or a PDSCH transmission.

A WTRU may transmit one or more messages and/or signals during a group-based initial access procedure. The messages and/or signals may include a random access preamble, which may also be referred to herein as a preamble. The random access preamble may include a conventional preamble that may be sent in Msg1 and/or MsgA. The random access preamble may include a preamble that may be selected by the WTRU in a contention-based manner and/or a dedicated preamble that may be designated by a network in a contention-free manner.

A random access preamble may be transmitted as a part of (but not limited to) a conventional random access procedure (e.g., a 4-step CBRA, 2-step CBRA, a 4-step CFRA type, a 2-step CFRA, etc.). A random access preamble may be sent in MSG1, Msg3, Msg5, and/or MSGA. A random access preamble (e.g., dedicated or common) may correspond to one WTRU and/or a group of WTRUs (e.g., a collaborative WTRU group). For at least contention-free random access procedures, a preamble may be dedicated or designated by a network for a WTRU and/or a WTRU group. The designation of a preamble for a WTRU and/or a WTRU group may be performed by a WTRU such as an anchor WTRU.

A network may provide a list of preambles that may be contention-free for a WTRU and/or a WTRU group to perform random access. Contention-free preambles and contention-based preambles may correspond to a same set of resources or to different sets of resources (e.g., one or more RACH occasions in the time domain, one or more PRACH occasions in the frequency domain, one or more SSBs corresponding to one or multiple beams in the spatial domain, etc.). A random access preamble may be encoded with an NAS ID of a WTRU and/or a WTRU group, e.g., through scrambling. For example, an NAS ID may comprise an ID that may uniquely identify a WTRU within the scope of any of the following: a WTRU group, a cell, a cell group (e.g., one or more cells), a session (e.g., a PDU session), and/or a network (e.g., a PLMN or RAN). In examples, a member WTRU may encode a preamble indicated by an anchor WTRU for a group-based initial access with an NAS ID of the member WTRU and may send the encoded preamble to a network, for example, in Msg1, MsgA, and/or Msg3. The network may unscramble the preamble and obtain the NAS ID of the member WTRU.

An association between preambles (e.g., RACH preambles) and service types (e.g., gaming, industrial robotic control, etc.) may be established (e.g., through a mapping relation) such that a WTRU (e.g., an anchor WTRU, a member WTRU, or a standalone WTRU) may access a set (e.g., a selected set) of preambles based on the type of service associated with an application running on the WTRU. A network device may (e.g., if the network device receives the same preamble from more than one WTRU and/or WTRU group) perform contention-resolution (e.g., by prioritizing one WTRU over another WTRU, and/or one WTRU group over another WTRU group) based on the service type(s) associated with the WTRUs or WTRU groups.

A random access preamble may convey additional information about a WTRU group. In examples, contention-based and/or contention-free preambles may be used or reserved for an initial access by a WTRU group (e.g., which may be interchangeably referred to herein as a group initial access). These preambles may implicitly inform a network about a group-based initial access. In examples, the preambles for a group initial access may be specifically indicated to a WTRU by the network, for example, in an SIB (e.g., SIB1, a subsequent periodic SIB, a subsequent requested SIB, and/or an XR-specific SIB). In examples, the designation of preambles for a group initial access may be explicit (e.g., through the addition of one or more extra bits in a configuration message). An indication such as a flag may be used to indicate a per-WTRU (e.g., solo) initial access or a group access. The indication may indicate the number and/or type of WTRUs in a group. In examples, some preambles may be reserved or allocated for a WTRU group with a specific number of WTRUs (e.g., within a number range). For example, preamble A may be allocated to a WTRU group with 2-4 WTRUs, while preamble B may be allocated to a WTRU group with 4-6 WTRUs. An anchor WTRU may select a preamble corresponding to the number of WTRUs in its WTRU group. In examples, the designation of preambles for a group initial access may be implicit. For example, there may be a common understanding between WTRUs and a network regarding the preambles to use for a group initial access (e.g., third preamble in every RACH occasion on odd-numbered SSBs on every other resource block). In examples, this common understanding may be on a per-cell or per-base station basis, and may be acquired by a WTRU, for example, when it first connects to the cell or gNB.

Upon transmission of a preamble, a WTRU may start a timer (e.g., T300 or another timer) to await a response message from a network (e.g., Msg2 or Msg4). For a group-based initial access, the length of this timer (e.g., which may be set by the WTRU) may be different than the length of a timer set for a WTRU-based initial access. The length of the timer may depend on any one or more of the following parameters. The length of the timer may depend on the delay tolerable by an XR application. For example, for a critical XR application that may be able to tolerate tight delay budgets, the length of the timer may be shorter than for an XR application that may be able to preserve a QoE with larger delay budgets. The length of the timer may be (e.g., in the case of a group initial access) a function of the number of WTRUs in the WTRU group. For example, the higher the number of WTRUs in the WTRU group, the longer the timer may be.

An anchor WTRU may send to one or more member WTRUs an indication of RACH resources (e.g., preamble and/or RACH occasions) that the member WTRUs may use for sending RACH related messages (e.g., Msg1 or MsgA) to a network. In examples, the anchor WTRU may indicate a common preamble for one or more (e.g., all) member WTRUs in the group to use at different designated RACH occasions in the time domain. In examples, the anchor WTRU may designate or assign a different preamble for each member WTRU to use. The preamble designated or assigned to a member WTRU by the anchor WTRU may be a contention-based and/or contention-free (e.g., for a solo or group-based initial access).

A WTRU such as an anchor WTRU of a WTRU group may confirm the allocation or assignment of resources. For example, an anchor WTRU of a WTRU group may send a confirmation of a resource allocation or assignment in the WTRU group to a base station following the determination and/or indication of the resource allocation (e.g., preambles, RACH occasions) to one or more member WTRUs of the WTRU group (e.g., including the anchor WTRU). The confirmation may indicate whether the RACH resource allocation or assignment to the one or more member WTRUs (e.g., including the anchor WTRU) was successful. In examples, the confirmation may include a single acknowledgment (ACK) indicating that an initial access was successful for one or more (e.g., all) members of the WTRU group. The confirmation may include additional information such as, e.g., which RACH resource was assigned to which WTRU in the group (e.g., Preamble #4 in RACH Occasion #2 assigned to member WTRU #2 in the WTRU group). The resource allocation or assignment to the member WTRUs may include information about the number and/or index of RACH occasions in the time domain, the number and/or indices of RACH occasions per PRACH slot in the time domain, the number and/or indices of PRACH occasions in the frequency domain, the SSBs associated with the aforementioned parameters (e.g., indices of two RACH occasions associated with the SSB with index #0), etc. The confirmation of the resource allocation or assignment may be reported to the network in the form of a mapping relation (e.g., a mapping table). For example, the anchor WTRU may send a mapping to a base station that may list the RACH resource(s) (e.g., preambles, preamble IDs, ROs, RO IDs, etc.) allocated to one or more member WTRUs (e.g., identified by respective WTRU IDs). The confirmation of the resource assignment may include information indicating an anchor WTRU NAS ID, a WTRU group ID, and/or the NAS ID(s) of one or more member WTRUs of the WTRU group. The information may be sent as standalone information (e.g., as uplink control information (UCI)) or as a part of a status report. In examples (e.g., where the anchor WTRU may make a group RRC setup request on behalf of the WTRU group), the confirmation may be accompanied by or include a group RRC request. In these examples, a member WTRU may not make an individual RRC request to the network. The confirmation of resource allocation or assignment may be sent in Msg3, Msg5, and/or MsgA.

One or more identifiers may be associated with a WTRU group. When transmitting a message, a WTRU may include one or more of an ID of a RACH preamble (e.g., used in Msg1, MsgA, or Msg3), an ID of the WTRU itself, an ID of a member WTRU (e.g., an NAS WTRU ID, a temporary mobile subscriber identity (TMSI), a C-RNTI, a TC-RNTI, or any other ID that may uniquely identify the WTRU), and/or an ID of the WTRU group (e.g., a group TC-RNTI, a group C-RNTI, or any other ID that may uniquely identify the WTRU group and/or the association of WTRUs to the WTRU group) in the message. An identifier of a WTRU or a WTRU group may be signaled by a network. For example, the network may signal a temporary C-RNTI assignment to a WTRU in a random access response message (e.g., such as Msg2 or MsgB). An anchor WTRU may send its NAS ID and/or that of a member WTRU to the network, e.g., in Msg3.

An anchor WTRU may send an RRC setup request on behalf of a WTRU (e.g., the anchor WTRU itself) and/or a WTRU group. A UL grant allocation included in a random access response (e.g., received in Msg2 or MsgB) may be used to transmit an RRC setup request and/or a group-based RRC setup request (e.g., in Msg3). In examples, the anchor WTRU may send a group RRC setup request, such that one or more member WTRUs may not have to send individual RRC setup request(s) on their own. In examples, the anchor WTRU may send an RRC setup request for itself, and a (e.g., each) member WTRU may send its own RRC setup request(s). In these examples, the anchor WTRU may send a request to the network for additional uplink grants that the anchor WTRU may forward to the member WTRUs to enable them to make individual RRC setup requests. The request to the network may be explicit or implicit. In examples, in response to receiving a preamble reserved for a group initial access from an anchor WTRU, the network may send additional uplink grant resources to the anchor WTRU (e.g., in a random access response). The amount of uplink grant resources that the network may send to the anchor WTRU may depend on the number of WTRUs in the WTRU group, which may have been indicated to the network by the anchor WTRU (e.g., explicitly in a RACH message or implicitly through the selection of certain preambles). The amount of uplink grant resources that the network may send to the anchor WTRU may be based on a default or average amount that the network allocates for group initial accesses. The RRC setup request may include a WTRU identifier, a WTRU group identifier, and/or an establishment cause. The establishment cause may include, for example, an emergency call, a high priority access, a WTRU group access, a multimedia priority access, etc.

A member WTRU of a WTRU group may transmit to an anchor WTRU location, orientation, and/or positioning information of the member WTRU. The anchor WTRU may use the location, orientation, and/or positioning information of the member WTRU to determine if the member WTRU may be a valid member of the WTRU group. In examples, the anchor WTRU may receive insufficient resources (e.g., RACH resources) from the network for a group-based initial access, and the anchor WTRU may use the location, orientation, and/or positioning information of the member WTRU to determine how to prioritize the member WTRU with respect to allocating the received RACH resources in the WTRU group.

The transmission of the location, orientation, and/or positioning information by the member WTRU to the anchor WTRU may be periodic (e.g., with a periodicity configured by the anchor WTRU, by an XR application, and/or by the network), semi-periodic (e.g., configured and activated/deactivated via a control message such as a PDCCH control message), and/or event-triggered. Example of events that may trigger the transmission of the location, orientation, and/or positioning information may include one or more of the following. The transmission may be triggered by the member WTRU detecting a change in its movement (e.g., beyond a preconfigured threshold), upon which the member WTRU may report the movement (e.g., new location information) to the anchor WTRU. The transmission may be triggered by the reception of an indication from a higher layer or an application. For example, the member WTRU may receive a request or indication from an XR application to report the location, orientation, and/or positioning information of the member WTRU to the anchor WTRU. The transmission may be triggered by the reception of an indication or request from the anchor WTRU to send the location, orientation, and/or positioning information. For example, the anchor WTRU may send a request to the member WTRU to report the location, orientation, and/or positioning information of the member WTRU if the anchor WTRU selecting member WTRUs to forward resources (e.g., group-based RACH resources provided by a network) for an initial access.

In examples, responsive to the member WTRU sending its location, orientation, and/or positioning information, the anchor WTRU may send an ACK to signal successful reception of the information. Failure to receive the ACK may trigger the member WTRU to re-send the information. The anchor WTRU may send a NACK to the member WTRU if the anchor WTRU has not received or is unable to successfully decode the location, orientation, and/or positioning information from the member WTRU. Reception of an NACK from the anchor WTRU may trigger the member WTRU to re-send the information. In examples, failure to receive a message from the network may trigger the member WTRU to send its location, orientation, and/or positioning information to the anchor WTRU and/or the network. For example, the member WTRU may be expecting a message from the network (e.g., Msg4) after sending the network a RACH preamble. The member WTRU may have started a timer after sending the preamble (e.g., in Msg1) to the network and, by the expiry of the timer, if the member WTRU has not received a response (e.g., Msg4) from the network, the member WTRU may send its location, orientation, and/or positioning information to the anchor WTRU or the network. In examples, the location, orientation, and/or positioning information of the member WTRU may be sent in response to a request from the network (e.g., either implicit or explicit), or the information may be sent as a result of receiving a NACK or failing to receive an ACK.

A network may over-allocate resources for a WTRU group, in which case an anchor WTRU of the WTRU group may send a cancel indication to the network. This may happen, for example, if the network is unaware of the number of WTRUs in the WTRU group and may have determined a resource assignment, for example, based on a default or average configuration for group-based initial access resources or based on previous requests from the anchor WTRU.

Messages and/or signals associated with a group-based initial access may be sent in various occasions. A WTRU may transmit one or more of the messages, signals, or information described herein in any of Msg1, Msg3, Msg5, or MsgA. A WTRU may send a preamble in Msg1 (e.g., alone or scrambled with an NAS ID). An anchor WTRU may transmit a preamble for its own initial access and/or for a group-based initial access to a network. The anchor WTRU may use (e.g., generate or be given) an ID to uniquely identify the WTRU group and/or may send the ID to the network (e.g., in Msg3 or Msg5). The anchor WTRU may send a confirmation of RACH resource allocation or assignment in the WTRU group to the network (e.g., in Msg3 or Msg5). The anchor WTRU may send its NAS ID and/or the NAS ID of a member WTRU (e.g., in Msg3 or Msg5) to the network.

A WTRU may transmit one or more of the messages, signals, or information described herein in any of Msg1, Msg3, Msg5, or MsgA based on one or more of the following. The WTRU (e.g., an anchor WTRU) may send a group-based RACH preamble (e.g., in Msg1 or MsgA) following an indication from an XR application to initiate a group initial access. The WTRU may send a RACH preamble following reception of an RA preamble assignment from a network (e.g., in a contention-free RA procedure). The WTRU may send a RACH preamble to the network following reception of indications from member WTRU(s) (e.g., received via a sidelink interface) to send the RACH preamble. The WTRU may send a request for a larger UL grant (e.g., more RACH resources) to the network in response to receiving an uplink grant (e.g., RACH resources granted via a random access response message) and determining that the UL grant is insufficient. A UL grant may be deemed insufficient if the WTRU (e.g., an anchor WTRU) cannot convey information about a group initial access to the network using the UL grant. This may be because the information conveyed by the WTRU (e.g., in Msg3) may include, for example, a confirmation of assignments, an anchor WTRU's WTRU ID, an individual member's WTRU ID, a WTRU group ID, etc., the details of which may require a larger UL grant. A UL grant may be deemed insufficient if, for example, the anchor WTRU may be unable to accommodate a large number of member WTRUs with the UL grant when the anchor WTRU receives indications from an application that the large number of WTRUs may all perform initial access within a stringent time window (e.g., to ensure the QoE of user experience).

A WTRU may receive and/or access resources and/or configuration information associated with an initial access to enable a group-based initial access. One or more of the initial access signals or messages described herein may be transmitted or received by the WTRU, for example, in and/or together with one or more of Msg1, Msg3, Msg5 (e.g., for a 4-step RA type), or MsgA (e.g., for a 2-step RA type) during an initial access procedure. The RACH resources and/or configuration information used by the WTRU for a group-based initial access may include one or more of the following. The RACH resources may include, for example, preambles, sequences, partitions, and/or time and/or frequency resources associated with the RACH procedure. The RACH resources may include one or more RACH occasions that the WTRU may use for transmitting RACH preambles. Parameters associated with the RACH resources may include start/stop times, a transmission duration, a periodicity, a transmission power, a transmission spatial direction, etc. The WTRU may select the RACH resources from a set of resources that may be common to multiple WTRUs or dedicated to the WTRU. The common or dedicated RACH resources may be indicated via a broadcast channel message or a beam (e.g., in an SIB, an SSB, etc.), via an initial access message (e.g., in Msg2 and/or MsgB), or via a configuration for the WTRU.

RACH resources accessible by a WTRU may be used for a general initial access, dedicated for a group-based initial access, and/or dedicated for other services or network slices (e.g., for XR services, for URLLC services, etc.). For example, the WTRU may have access to two sets or partitions of RACH resources, wherein a first set of RACH resources may be intended for group-based initial access purposes and a second set of RACH resources may be intended for non-group based initial access purposes. The different resources or resource sets may be associated with respective IDs or indices that may be received by the WTRU via broadcast or dedicated signaling.

A WTRU may have access to a set of one or more group-based RACH preambles. The WTRU may select a RACH preamble randomly or based on a selection criteria. For example, such a selection criteria may indicate selection of a group-based RACH preamble if an RSRP measured on an DL signal (e.g., SIB, DL PRS, DMRS, SSB, TRS, CSI-RS, etc.) associated with a RACH procedure is above or below a threshold value.

A WTRU may implicitly indicate to a network information related to a WTRU group. The WTRU may do so, for example, by transmitting a UL signal using group-based RACH resources. For instance, the WTRU may send a designated group-based preamble to the network, which may signal a group-based initial access.

A resource, resource set, and/or configuration (e.g., as a whole or in part) associated with a group-based initial access (e.g., by sending a RACH indication or request) may be received by a WTRU in a combination of one or more of the following scenarios, for example, before or during the initial access.

The WTRU may receive information regarding RACH resources and/or occasions (e.g., group-based or non-group-based) on a broad channel such as via an SIB and/or an SSB. The resources, resource sets and/or configurations that may be used by the WTRU during an initial access or after establishing connectivity with a network (e.g., in an RRC_CONNECTED state) may be indicated with IDs and/or index values. In examples, the WTRU may receive information on the occasions during which the WTRU may transmit one or more of the initial access signals that the network may expect to receive for handling WTRU group-based initial access. In examples, the WTRU may receive information (e.g., IDs) regarding the parameters associated with a UL transmission (e.g., a group-based RACH, a PUSCH, etc.). These parameters may include, for example, a transmission power (e.g., as a range of values or a max value) to be applied, offset values with respect to a reference frame, numerology, QCL/spatial relation, TRP/cell ID, beam IDs, spatial direction to apply, etc. The parameters may be used by the WTRU to transmit initial access signals and/or make other requests related to an initial access (e.g., an on-demand request sent in Msg1, Msg3, or MsgA).

The WTRU may receive information regarding RACH resources via a paging message. For example, the WTRU may be transitioning into an RRC_IDLE or INACTVE state (e.g., after a previous connection establishment and/or operation in the RRC_CONNECTED state), and the WTRU may receive information on the resources for sending initial access signals in one or more paging messages. In this case, the one or more paging messages received by the WTRU may include a WTRU ID (e.g., a paging RNTI) and/or resources, configurations, and/or IDs/indices associated with a UL signal (e.g., transmitted on a RACH or PUSCH). In examples, the WTRU may receive the information regarding the RACH resources in conventional paging occasions or in paging occasions dedicated for positioning.

The RACH resources may be pre-configured or pre-defined for the WTRU. For example, the WTRU may use resources pre-configured (or pre-defined) for and stored in the WTRU for transmitting or receiving initial access signals. The WTRU may receive the pre-configuration through previous connectivity (e.g., previous PDU sessions) and/or previous RRC configurations (e.g., received by the WTRU in an RRC_CONNECTED state), for example. In examples, the pre-configured resources for initial access signals may be received when the WTRU transitions to an RRC_INACTIVE or RRC_IDLE state (e.g., in one or more RRC release messages such as a Suspend Config message, or one or more RRC reconfiguration messages). In examples, the WTRU may receive validity information, conditions, and/or criteria associated with pre-configured resources when the WTRU receives pre-configured resources for initial access signals. Such validity conditions may include validity areas (e.g., list of cells), validity times (e.g., timer or timer durations), and/or validity measurement thresholds (e.g., thresholds corresponding to RSRP measurements of DL signals associated with the initial access signals). The validity conditions may indicate conditions expected to be met for deciding whether pre-configured resources for initial access signals are valid.

The WTRU may receive information regarding RACH resources during transmission and/or reception of initial access messages. For example, the WTRU may receive resources for initial access signals (e.g., transmitted on a RACH or PUSCH) for a group-based initial access in one or more of Msg2 (e.g., a random access response message), Msg4 (e.g., for a 4-step RA type), and/or MsgB (e.g., for a 2-step RA type) receptions. The WTRU may receive the resources upon transmitting an explicit or implicit request for resources for the group-based initial access in Msg1, Msg3, or MsgA, for example.

The WTRU may transmit an explicit request for resources to be used for a group-based initial access by transmitting a RACH indication in Msg1 or MsgA along with a request indication or a flag (e.g., indicating that the initial access is group-based) and/or by transmitting a RACH signal encoded or scrambled with a request indication. The WTRU may transmit an implicit request for UL resources when transmitting a RACH preamble or partition that may be associated with a request indication for a group-based initial access. The WTRU may transmit an implicit request for resources by transmitting a RACH preamble during a RACH occasion that may be associated with, dedicate, and/or/reserved for such a request.

The WTRU may receive resources for a group-based initial access in one or more search spaces associated with a BWP and/or in different BWPs. For example, the WTRU may be configured with an association or a mapping relation between RACH signals for Msg1/MsgA and one or more search spaces to monitor for an RAR (e.g., Msg2 or MsgB) or an activation/deactivation indication (e.g., an ID or index for a group-based initial access). Such an association or mapping relation may be received by the WTRU in a broadcast channel message (e.g., a SIB) or an RRC message (e.g., an RRC release or RRC reconfiguration message). Such an association or mapping relation may be pre-configured for the WTRU. If the RACH signal used by the WTRU includes an explicit or implicit indication for resources or activation of preconfigured resources, the WTRU may receive the resources or an indication of the activation/deactivation of the resources in the one or more search spaces associated with the RACH signal.

The WTRU may identify resources and/or configurations for a group-based initial access based on semi-static configuration information between the resources and one or more of the following: a service type (e.g., XR or URLLC), a cell type, a base station type (e.g., a gNB, a TRP, an IAB node), and/or a PLMN type (e.g., public or private network). Such semi-static configuration information may be received by the WTRU in a broadcast channel (e.g., via an SIB) or an RRC message, or the semi-static configuration information may be pre-configured for the WTRU. For example, when triggering WTRU group-based initial access (e.g., for XR services), the WTRU may determine the resources for transmitting initial access signals (e.g., on a RACH or PUSCH) based on semi-static configuration information received in an SIB that may indicate a mapping between XR services and resources.

A WTRU (e.g., an anchor WTRU) may receive an uplink grant, e.g., as part of a random access response (RAR) message that may be received in Msg2 or MsgB). The UL grant received by the WTRU may be for itself and/or for a WTRU group, in which case the WTRU may distribute the grant to members of the WTRU group. The WTRU may use the uplink grant to send an RRC setup request for itself or to send a group RRC setup request, such that members of the WTRU group may not have to send individual RRC setup requests. If the size of the UL grant is not large enough (e.g., for transmitting indications about a group initial access and/or for an anchor WTRU to distribute the UL grant to member WTRU(s) for sending their respective RRC requests), the WTRU may send a request for a larger UL grant and may receive such a larger UL grant from the network in one or more subsequent messages (e.g., after reception of an RAR message). The member of the WTRU group may receive an UL grant from an anchor WTRU and/or from a network.

A network may estimate a timing advance for a WTRU or a WTRU group based on a preamble received by the network (e.g., in Msg1 or MsgA) and may send a TA value to a WTRU (e.g., an anchor WTRU of the WTRU group) in an RAR message. The TA value may be based on a propagation delay that may vary in accordance with a distance between a WTRU and the network (e.g., a gNB or transmitter tower). The TA value received by a WTRU from the network may be a function of an indication sent by the WTRU in previous messages. For example, an anchor WTRU may send one or more indications to a base station regarding delay budgets tolerable by an application and the base station may configure a timing advance for the anchor WTRU or a WTRU group based on the indications (e.g., in addition to a propagation delay).

An anchor WTRU may receive a TA (e.g., a common TA) from a network that may be applicable for multiple (e.g., all) WTRUs in a WTRU group (e.g., if the WTRUs are collocated) associated with the anchor WTRU. The TA may be used for a group initial access. In the event that the anchor WTRU may have received fewer resources (e.g., RACH preambles, random access occasions (ROs), etc.) than it requested for a group-based initial access procedure, the anchor WTRU may prioritize one or more member WTRUs for the resources and may take the TA value indicated by the network into account when determining which member WTRUs should receive the resources. For example, if a member WTRU has indicated a change in its positioning, location, and/or orientation to the anchor WTRU such that the member WTRU is determined to be further away (e.g., beyond a radius pre-defined by an application), the anchor WTRU may determine that this member WTRU may not be able to perform an initial access within the TA indicated by the network and may de-prioritize the member WTRU.

A network may signal an identifier associated with a WTRU and/or a WTRU group to the WTRU. For example, the network may signal a temporary C-RNTI (TC-RNTI) or a group TC-RNTI to a WTRU in a random access response message (e.g., Msg2 or MsgB). As another example, after an anchor WTRU sends to a network (e.g., a gNB) an indication of a group initial access and/or the number of WTRUs included in the WTRU group, the anchor WTRU and/or one or more member WTRUs of the WTRU group may receive a group TC-RNTI.

An RAR message may correspond to Msg2 or MsgB described herein. The content of an RAR message may include, for example, a timing advance and/or a UL grant for an anchor WTRU, a UL grant for a member WTRU, and/or a UL grant for a WTRU group. The time resources, frequency resources, and/or a downlink MCS associated with an RAR message may be indicated to a WTRU in DCI (e.g., in a PDCCH transmission) for the WTRU to know when to expect the RAR message and/or how to decode the RAR message. This indication from the network may be scrambled with a receiving WTRU identifier and/or a WTRU group identifier.

A WTRU may receive an RRC setup message (e.g., in Msg4) from a network. For example, an anchor WTRU of a WTRU group may receive an RRC setup message (e.g., as a final message) before transitioning to a connected state. A DCI scrambled with a WTRU C-RNTI and/or a group C-RNTI may indicate the frequency and/or time resources assigned for transmitting a transport block containing an RRC setup message so that one or more corresponding WTRUs may be aware of when to expect or monitor for an RRC setup message. The RRC setup message may be designated to the anchor WTRU, the WTRU group, and/or one or multiple members of the WTRU group. The RRC setup message may be sent to set up a signal radio bearer (SRB) such as SRB 1 and/or a cell such as a master cell. The RRC setup message may include information elements such as radioBearerConfig and masterCellGroup. The anchor WTRU may stop a timer after receiving the RRC setup message. For example, the anchor WTRU may start a timer (e.g., timer T300) after sending a preamble and may stop the timer after receiving the RRC setup message (e.g., in Msg4 or MsgB).

A WTRU may receive information from an application or a higher layer regarding the maintenance of a QoE. The information may include, for example, a maximum time duration for a WTRU group to establish connectivity with a network (e.g., a time window for performing initial access), a priority of a (e.g., each) member WTRU, an NAS ID of a member WTRU, and/or an ID uniquely identifying a WTRU to an application.

An anchor WTRU may receive assistance information from one or more member WTRUs (e.g., of a WTRU group) to enable the coordination of a group-based initial access procedure. The assistance information may include an identifier of a member WTRU (e.g., a C-RNTI or NAS ID or any other ID that may uniquely identify the member WTRU). The assistance information may include capability information associated with a connectivity including, for example, information about interfaces such as the number of interfaces and/or types of interfaces (e.g., NR Uu, NR SL, WiLAN, and/or Bluetooth, etc.) supported by a WTRU within the WTRU group. The assistance information may include capability information about interfaces that may be supported by a WTRU and/or required or used by a WTRU for supporting an XR action in other WTRUs. Such information may include any of the following: a bandwidth, a number of carriers, a number of transmit antennas, a number of receive antennas, antenna configurations, etc. In examples, antenna configuration information may implicitly indicate to the anchor WTRU the range of SSB(s) that a member WTRU may be able to measure and/or report. Static capability information exchange may occur at the start of an XR session (e.g., regarding the types of supported interfaces), while more dynamic capability information exchange may occur when (e.g., every time) a change is detected (e.g., a member WTRU may send a notification to the anchor WTRU that may indicate a change in an antenna configuration).

The anchor WTRU may receive information from a member WTRU about a link failure, blockage, poor channel quality, etc., detected at the member WTRU. In examples, the anchor WTRU may determine that a member WTRU may not be able to perform an initial access within a timing advance value indicated by a network (e.g., in a random access response message) due to a link failure at the member WTRU. In response, the anchor WTRU may decide not to include the member WTRU in a group initial access procedure. In examples, the anchor WTRU may send a group RRC request if a member WTRU is experiencing temporary poor channel conditions that my limit the transmission and/or reception of the member WTRU.

A WTRU may start a timer, for example, upon sending Msg1, Msg3 and/or MsgA. The length of the timer may be set based on the delay budgets tolerable by an XR application. At the expiration of the timer, the WTRU may expect a status report (e.g., in Msg4 or MsgB) from a network. The status report may indicate whether or not an initial access by multiple (e.g., all) WTRUs of a WTRU group is successful. The indication may be on a group basis or a per-WTRU basis.

Information (e.g., configuration information) may be exchanged between a WTRU and a network to obtain a common understanding of the ways to read, decode, or interpret a status report such an RAR. For example, “Successful” in the context of such a status report may imply success in completing an initial access procedure and “Unsuccessful” in this context may imply a failure in completing the initial access procedure. In examples, a failure in completing an initial access procedure may result from a member WTRU failing to send Msg1 and/or MsgA, or failing to send a version of Msg1/Msg A with a designated preamble to the network. In examples, a failure in completing an initial access procedure may result from the network failing to receive and/or decode Msg1 and/or MsgA, and/or failing to receive and/or decode a version of Msg1/Msg A from a member WTRU. In examples, a failure in completing an initial access procedure may result from the network failing to decode Msg1 and/or MsgA, and/or failing to decode a version of Msg1/Msg A from a member WTRU before the expiration of a time window.

A status report such as an RAR may be designated to an anchor WTRU, a member WTRU, and/or a WTRU group such that a (e.g., any) member of the WTRU group (e.g., including an anchor WTRU and/or a member WTRU) may decode the report. For example, if a status report indicates a WTRU group NAS ID, an anchor WTRU may assume that an initial access for multiple (e.g., all) members of the WTRU group (e.g., including the anchor WTRU) is successful. As another example, a status report may explicitly indicate the NAS IDs of successful WTRU(s) and unsuccessful WTRU(s). If a member WTRU is unsuccessful with an initial access, the anchor WTRU may send assistance information to the member WTRU. The anchor WTRU may, for example, send an indication to the unsuccessful member WTRU to have the member WTRU re-attempt an initial access by re-sending Msg1 or MsgA using the same RACH resources for another n times (n≥1), using the same power, or using an increased power. The anchor WTRU may indicate to the unsuccessful member WTRU that the re-attempted initial access (e.g., by sending Msg1 or MsgA) may use RACH resources (e.g., preambles) that may have been used by another member WTRU in a successful initial access (e.g., in a RACH occasion determined by the anchor WTRU). The anchor WTRU may designate multiple RACH occasions for re-attempting the initial access for another n times (n≥1) with the same power or with an increased power.

A status report may indicate the NAS ID(s) of member WTRU(s) that are successful with an initial access. Based on such a status report, an anchor WTRU may deduce that at least one member WTRU has been unsuccessful with an initial access and may send assistance information (e.g., directly) to the unsuccessful member WTRU. For example, the anchor WTRU may indicate one or more determined RACH resources via a sidelink interface to the unsuccessful WTRU for re-transmitting Msg1 or MsgA.

A status report may indicate one or more solutions for an unsuccessful initial access. For example, a network may send an indication to a WTRU regarding the validity of previously allocated RACH resources (e.g., preambles, ROs, etc.). An anchor WTRU may consider the validity information when designating resources to one or more member WTRUs for re-trying an initial access following a failed attempt. As another example, a member WTRU may receive and decode a status report (e.g., in Msg4), and may send a renewed request (e.g., Msg1 or MsgA) to a network using the validity information of available RACH resources. As yet another example, if an anchor WTRU is unsuccessful with its random access procedure, the anchor WTRU may determine that one or more member WTRUs are successful in their random access procedures (e.g., via direct communication with the member WTRUs via a sidelink), and the anchor WTRU may perform a stand-alone RACH procedure (e.g., a 2-step RACH procedure) based on the resource validity information indicated by the network.

A WTRU may transmit initial access signals associated with a group-based initial access based on detection of a triggering event or condition. The triggering events or conditions may include a combination of one or more of the following. The triggering events may include reception of an indication from a higher layer or an application. For example, the WTRU may trigger the group-based initial access upon receiving a higher layer or an application request or indication for such initial access. The WTRU may select a group-based RACH preamble and transmit the selected preamble in a RACH occasion configured for the group-based initial access. The triggering events may include detection of one or more reference locations. For example, the WTRU may trigger the group-based initial access upon detecting one or more TRPs, one or more base stations, or one or more cells (e.g., via an SIB or SSB) that may support the group-based initial access. In examples, the WTRU may be operating in an INACTIVE or IDLE state, and may be pre-configured with a validity area (e.g., a list of cells) for performing the group-based initial access. In response to detecting a cell ID that matches at least one cell in the validity area, the WTRU may start the group-based initial access procedure.

The triggering events may include a priority associated with the group-based initial access. For example, the WTRU may trigger the group-based initial access if a priority value associated with the group based initial access is higher than a priority associated with a non-group-based initial access. The priority value(s) may be pre-configured in the WTRU or received by the WTRU via an SIB for low latency collaborative XR, for example.

If the WTRU is operating in an INACTIVE/IDLE state, the WTRU may trigger the group-based initial access in response to determining that the location of one or more WTRUs in the WTRU group has changed beyond a certain threshold, that the RSRP measurements of a DL signal or channel made by the WTRU in the WTRU group are above or below a threshold value, etc. The WTRU (e.g., which may be an anchor WTRU or a member WTRU in the WTRU group) may be configured to perform the group-based initial access periodically, in which case, the WTRU may trigger the group-based initial access based on the configured periodicity.

The triggering events may include detection of a cell that may support the group-based initial access. For example, if the WTRU discovers more than one cell and at least one of the discovered cells supports the group-based initial access, the WTRU may prioritize the group-based initial access to the cell(s) that supports the group-based initial access.

The triggering events may include reception of broadcast information that may include positioning related information. For example, the WTRU may determine to start the group-based initial access if an SIB or SSB includes information or indications related to the group-based initial access (e.g., an indication for the WTRU to start the initial access).

A WTRU may perform measurements to facilitate a group-based initial access procedure. In examples, a member WTRU of a WTRU group that experiences a beam failure may perform a beam failure recovery by performing related beam measurements (e.g., SSB measurements such as SS-RSRP, SS-RSRPB, SS-RSRQ, SS-SINR, etc.) and/or a RACH procedure. An anchor WTRU of the WTRU group may assist the member WTRU in the beam recovery process, for example, based on the anchor WTRU's own beam measurements, which may include SSB beams and/or CSI-RS measurements (e.g., if the anchor WTRU is in a connected state). While in the connected state, the anchor WTRU may map one or more CSI-RS beams (e.g., narrow CSI-RS beams) to wider SSB beams based on QCL states and/or a TCI state configuration. The anchor WTRU may indicate a subset of SSB beams to be considered for beam measurement. The subset of SSB beams may be based on, for example, k strongest beams that may satisfy a minimum RSRP requirement. The anchor WTRU may indicate this information to a network (e.g., via a Uu link) and/or to a member WTRU (e.g., directly via a sidelink) of the WTRU group.

In examples, if the anchor WTRU experiences a beam failure, it may communicate with one or more member WTRUs in the WTRU group to check the status of their connections. The member WTRUs may perform beam measurements on a subset of beams or all of the beams (e.g., SSB measurements such as SS-RSRP, SS-RSRPB, SS-RSRQ, SS-SINR, etc.) and may report the measurements to the anchor WTRU (e.g., as a response to a notification message from the anchor WTRU indicating a beam failure).

In examples, if measurement by the anchor WTRU indicate a potential Uu beam failure and/or that the RSRP of a serving beam drops to a value that approaches a threshold for a continued usage of the beam, the anchor WTRU may choose not to provide a member WTRU with a subset of beams, and may allow the member WTRU to perform beam measurement over an SSB beam set (e.g., an entire SSB beam set) or a set of beams that the member WTRU may deem suitable.

In examples, the anchor WTRU may be aware of other devices in its WTRU group that may have experienced beam failures and/or beam recovery. The anchor WTRU may choose to exclude failed SSB beam measurements from the measurement set that the anchor WTRU may indicate to a member WTRU (e.g., which may have experienced a beam failure). In examples, the anchor WTRU may choose to indicate a limited SSB beam measurement set, which may include a list of beams based on the anchor WTRU's own measurements and/or the SSB beams of a recent set (e.g., a most recent set) of member WTRUs that may have recovered from beam failures.

In examples, the set of beams that the anchor WTRU may want a member WTRU (e.g., a new member to the WTRU group) to consider may include (e.g., only include) the SSB beams that have been selected by multiple (e.g., all) WTRUs in the group (e.g., by the anchor WTRU and/or any of the member WTRUs), or a subset of the SSBs selected by existing member WTRUs in the WTRU group (e.g., by the anchor WTRU and/or any of the member WTRUs).

In examples, the state of the WTRUs in a WTRU group may be considered for beam selection and/or a RACH procedure. For example, if a member WTRU is transitioning from an RRC_Idle state to an RRC_Connected state, the member WTRU may (e.g., based on an indication by the anchor WTRU) perform beam sweeping or beam measurement in order to find the best SSB beam set. In this case, a reduced beam measurement set may not be indicated for the member WTRU. Such behaviors may be suitable at least when the anchor WTRU decides not to restrict an SSB beam measurement or selection process. The behaviors may be suitable, for example, in a scenario where a member WTRU may not be located in the proximity of the anchor WTRU or may have moved further away from the anchor WTRU since a previous beam measurement. The behaviors may be suitable if a member WTRU is attempting to recover from an RLF (e.g., due to blockage) and the anchor WTRU determines that the member WTRU should perform the beam measurements it would perform if operating as a standalone WTRU (e.g., not being a part of the WTRU group).

In examples, if a member WTRU is attempting to transition from an RRC_Inactive state to an RRC_Connected state, it may not be necessary for the member WTRU to perform an exhaustive beam sweeping, and the member WTRU may start with a previous SSB beam measurement set and perform additional sweeping or measurements if the link quality of those beams is below a threshold. The anchor WTRU may provide the member WTRU with a beam measurement set (e.g., via a sidelink), which may be based on the anchor WTRU's own measurements and/or beam measurement information provided by other WTRUs in the WTRU group.

In examples, a member WTRU may be transitioning from an RRC_Inactive state to an RRC_Connected state, and the member WTRU may decide to start with a previous SSB measurement set and perform measurement for (e.g., only for) differential beams (e.g., due to movement of the member WTRU). In examples, SSB measurements (e.g., RSRP, RSRQ, etc.) may be used as an implicit trigger to decide which RACH process (e.g., 2-step or 4-step) to use. If a WTRU is configured with both 2-step and 4-step random access resources, the WTRU may check the value of a configuration parameter (e.g., such as msgA-RSRPthreshold) to determine whether to perform a 2-step RACH or a 4-step RACH. The determination to perform the 2-step RACH or the 4-step RACH may depend on other parameters (e.g., in addition to the value of msgA-RSRPthreshold) including, e.g., indications from an application for an anchor WTRU and a member WTRU. For example, even if a WTRU meets the requirements for a 2-step RACH process (e.g., having a high msgA-RSRPthreshold value), the WTRU may receive an indication from an XR application to perform a 4-step RACH (e.g., because UL data is not low-latency in nature). An indication of the applicable RACH method may be provided by the anchor WTRU (e.g., via a sidelink), for example, if the anchor WTRU is in an RRC_Connected state or RRC_Inactive state. The anchor WTRU may consider the QoS of one or more WTRUs (e.g., all of the WTRUs) in a WTRU group when providing the indication to a member WTRU. For example, two member WTRUs may be attempting to transition to an RRC_Connected state and may have different application-level latency needs. In such cases, the anchor WTRU may instruct one member WTRU (e.g., with lower latency needs) to utilize 2-step RACH and the other member WTRU to utilize 4-step RACH.

In examples, the power constraints of a WTRU may be used to determine whether the WTRU should perform a 2-step RACH or a 4-step RACH. For example, if the WTRU is power constrained and/or is operating under a scenario where it has to make relatively infrequent small data transmissions, the WTRU may select the 2-step RACH.

In examples, an anchor WTRU may use information from another WTRU group (e.g., based on communication between the anchor WTRU and an anchor WTRU of the other group) for one or more of the operations described herein. The anchor WTRUs of the two groups may, for example, exchange information with regards to SSB and/or CSI-RS beam indices that may be used by various member WTRUs in each WTRU group. For example, if the two WTRU groups are in close proximity, they may be covered by common SSB beams and the anchor WTRUs may share this information to reduce the number of beam sweeps and/or measurements that may be performed for beam establishment. As another example, if the two WTRU groups have overlapping coverage, the groups (e.g., via coordination of the anchor WTRUs) may coordinate beam selection and/or measurement across the groups.

In examples, an anchor WTRU of a WTRU group with n WTRUs may start a group-based RACH procedure. The anchor WTRU may receive a set of RACH resources (e.g., contention-free RACH preambles, ROs, etc., that may be of the same size or different sizes) sufficient for a subset of the n WTRUs (e.g., for m WTRUs, where m<=n). In this situation, the anchor WTRU may assign or allocate the received RACH resources (e.g., which may be referred to herein as m resources) among the n members of the WTRU group based on criteria that may include latency tolerance, reliability requirements, priorities, etc. associated with the member WTRUs. For example, the anchor WTRU may allocate the m resources within the WTRU group based on which WTRU may have latency critical requirements (e.g., more stringent transmission time constraints) and/or which WTRU may have a higher priority.

In examples, an anchor WTRU of a WTRU group may allocate dedicated RACH preambles to members of the WTRU group based on the category or type of the members. For example, an XR application experience may involve a WTRU group that includes audio and/or video capturing devices, sensors, etc. An anchor WTRU of such a WTRU group may allocate RACH preambles based on the device category or type of the member WTRUs, and/or the priority and/or QoE associated with the XR application. For example, audio devices in the WTRU group may be prioritized as they may have more stringent latency requirements related to user feedback and/or user experience, whereas video and/or high data volume devices in the WTRU group may be given a lower priority since they may be more tolerant with delays.

In examples, an anchor WTRU of a WTRU group may determine which WTRU(s) in the group should be given a RACH resource (e.g., a dedicated RACH resource) based on overlaps in the user plane data of multiple WTRUs. For example, multiple WTRU in the WTRU group may have a common FoV and/or an overlapping communication range that the anchor WTRU may be aware of (e.g., via information exchange between the WTRUs that may include application layer data, based on information received from a base station, etc.). In such a scenario, the anchor WTRU may select a (e.g., just one) WTRU of the multiple WTRUs to receive a RACH resource. As another example, if a FoV is covered by multiple WTRUs in an RRC_Connected state, the anchor WTRU may exclude the WTRU(s) whose FOV may be covered by the multiple WTRUs and may prioritize other WTRU for a RACH resource (e.g., if the network has provided insufficient resources for allocation in the WTRU group).

In examples, if some WTRUs are also part of an additional WTRU group (e.g., which may be inferred or determined based on communication between respective anchor WTRUs of the WTRU groups or based on information provided by a base station), the anchor WTRUs for these WTRU groups may coordinate with respect to which WTRUs may be given a higher priority during allocation of RACH resources. For example, if a WTRU is a part of two different WTRU groups and one of the WTRU groups has better channel conditions (e.g., better RSRP/SINR, etc.) compared to the other one of the WTRU groups, the network (e.g., a base station) may assign RACH resources to the WTRU group having better channel conditions (e.g., if the network does not have enough RACH resources to accommodate both WTRU groups).

A WTRU in a WTRU group may perform a RACH-less initial access procedure. A RACH-less initial access procedure may refer to the process whereby a WTRU may be able to directly send data in an uplink without completing a random initial access. For example, a member WTRU of the WTRU group may directly transmit data to the network (e.g., similar to transmitting data via Msg3 in a 4-step RACH procedure) based on a grant allocated by the network (e.g., similar to what the WTRU may receive via Msg 2).

A member WTRU of a WTRU group may receive assistance information from an anchor WTRU of the group such that the member WTRU may be able to perform a RACH-less initial access procedure, for example, if the anchor WTRU is on the same SSB and/or narrow beam as the member WTRU. In examples, the anchor WTRU may perform measurements on candidate SSB beams and may send the information to the member WTRU. The anchor WTRU may request an UL grant from a network on behalf of the member WTRU, receive the UL grant, and forward the UL grant to the member WTRU. The UL grant may be designated for the anchor WTRU or the member WTRU, or it may be a part of a grant designated for the WTRU group that the anchor WTRU may have distributed or partitioned among multiple member WTRUs. Using the resources provided by the anchor WTRU (e.g., the uplink grant, a timing advance for synchronization, an SSB beam indication or measurement, etc.), the member WTRU may perform a RACH-less initial access procedure (e.g., without transmitting a RACH preamble).

A member WTRU of a WTRU group may receive, from a network and/or an anchor WTRU of the WTRU group, an indication of one or more conditions that the member WTRU may satisfy in order to perform a RACH-less initial access procedure. For example, the member WTRU may perform a RACH-less initial access procedure if an SSB measurement made by the member WTRU is substantially close (e.g., within a threshold) to an SSB measurement made by the anchor WTRU. The member WTRU may perform a RACH-less initial access procedure if the distance between the member WTRU and the anchor WTRU is sufficiently close (e.g., within a threshold). The member WTRU may perform a RACH-less initial access procedure if a configured timer (e.g., a TA timer) associated with the anchor WTRU and/or the member WTRU is running and/or not expired. The member WTRU may perform a RACH-less initial access procedure if the member WTRU is coming out of an idle mode, while the anchor WTRU is in a connected mode and/or has updated measurements on SSBs.

A member WTRU may operate in a low power state such as an RRC Inactive state or an RRC Idle state, while an anchor WTRU (e.g., in a WTRU group) may be in an RRC Connected state. The member WTRU may or may not keep its configuration information in such a lower power state and the anchor WTRU may keep the configuration information for the member WTRU. For example, if the anchor WTRU is a pair of AR glasses and the member WTRU is a pair of haptics gloves (e.g., both may be parts of the same XR application, session, or experience), the member WTRU may be less capable (e.g., in terms of supporting functionalities or features associated with the member WTRU's role in the XR experience), and/or may have reduced capabilities (e.g., the member WTRU may save battery and/or memory by only storing information relevant to the XR experience). In this case, the member WTRU (e.g., the haptics gloves) may or may not keep its RRC context when it goes into the RRC Inactive state. The member WTRU may obtain (e.g., receive or retrieve) the RRC context from the anchor WTRU (e.g., the AR glasses) when the RRC context is needed.

The member WTRU may store its RRC context information at the anchor WTRU (e.g., when the member WTRU transitions to the RRC idle state) so that a transition (e.g., from the RRC idle state) by the member WTRU to the RRC Connected state may be fast (e.g., without core network signaling). As a notification in this scenario, the anchor WTRU may be configured to send paging-type messages to the member WTRU (e.g. via a sidelink), and the member WTRU may be configured to monitor for the paging-type messages from the anchor WTRU, with indications from the anchor WTRU (e.g., included in SCI) on the time/frequency resources used for transmitting or receiving the paging-type messages.

A WTRU (e.g., an XR WTRU) of a WTRU group may be configured to send paging messages and/or receive paging messages. The WTRU may be configured to monitor for paging messages from the network and/or from an anchor WTRU of the WTRU group (e.g., to determine when to wake up). In an example, if the member WTRU is in an idle state or mode, and knows that its RRC context information is stored at the anchor WTRU, the member WTRU may prioritize paging messages from the anchor WTRU over paging messages from the network. The member WTRU may monitor (e.g., only monitor) for paging messages from the anchor WTRU in such a scenario. The member WTRU may receive an indication from the anchor WTRU to monitor for paging messages from the anchor WTRU (e.g., on specific time-frequency resources) during a time period (e.g., for the entire duration while the member WTRU is in the idle state, or for a specific number of cycles, slots, or transmission occasions). The member WTRU may receive an indication or message from the network (e.g., a similar indication or message as that received from the anchor WTRU) to monitor (e.g., only monitor) for paging messages from the network during a time period (e.g., while the member WTRU is in the idle state, or for a specific number of cycles, slots, or transmission occasions while in the idle state).

The member WTRU may receive conflicting messages from the network and the anchor WTRU regarding the monitoring of paging messages. The member WTRU may determine whether to prioritize the network or the anchor WTRU with respect to the paging messages. For example, if the anchor WTRU (e.g., a pair of AR glasses) and the member WTRU (e.g., a pair of haptics gloves) are involved in an XR experience (e.g., the member WTRU may operate to augment the XR experience run by an application on the anchor WTRU), the member WTRU may choose to monitor for paging messages from the anchor WTRU (e.g., only from the anchor WTRU), for example, when the member WTRU is in an idle state. In another example, the member WTRU may be another pair of AR glasses (e.g., the anchor WTRU may be one pair of AR glasses belonging to one user and the member WTRU may be another pair of AR glasses belonging to a different user). In such an example, the member WTRU may choose to monitor for paging messages from the anchor WTRU and the network (e.g., when the member WTRU is in an idle state), and in case of conflicting instructions (e.g., from the network and the anchor WTRU), the member WTRU may prioritize the paging messages from the network.

In examples (e.g., if the network has been notified about a WTRU group and/or the group members with respective WTRU IDs), the network may transmit paging messages to a designated anchor WTRU (e.g., only to the anchor WTRU), for example, to reduce the overhead associated with paging message transmissions. For instance, with existing communication technologies, paging transmissions may take place in cells where a target WTRU may not be located, leading to unnecessary signaling overhead. On the other hand, if paging messages are only transmitted in the cell in which the target WTRU is located, the WTRU may have to inform the network about whether and/or when the WTRU moves out of the coverage area of one cell and into the coverage area of another cell (e.g., in order to track the WTRU at a cell level). This may also lead to increased signaling overhead (e.g., in terms of signaling performed to inform the network about the updated WTRU location). A compromise may be made, under which the network may leverage the WTRU group to page (e.g., only page) the designated anchor WTRU if the network desires to communicate with a member WTRU in the WTRU group, and the anchor WTRU may forward the paging message to the member WTRU (e.g., the network may avoid paging the member WTRU individually).

A member WTRU may verify an anchor WTRU's capability for storing RRC context information if the anchor WTRU is configured to save the RRC context of the member WTRU (e.g., when the member WTRU is in an idle or inactive state). The verification may be performed, for example, before the member WTRU transitions to the inactive or idle state. In an example, the anchor WTRU may be capable of storing RRC context information for a specific number of (e.g., two) member WTRUs at a given time. If another (e.g., a third) member WTRU in the WTRU group transitions to the inactive or idle state, the member WTRU may be configured to wait for a period of time (e.g., a number of cycles or slots) before going into the inactive or idle state. The duration of the waiting period (e.g., the number of cycles or slots) may be indicated to the member WTRU (e.g., from the anchor WTRU). In examples, the anchor WTRU may have knowledge about the traffic characteristics of a member WTRU in the idle state or mode, and may be able to estimate the time it may take for the member WTRU to transition from the idle state to a connected or inactive state. In examples, the anchor WTRU may send a paging message to one or more of the member WTRUs (e.g., the two WTRUs described above) that may be supported by the anchor WTRU and/or currently in an idle state to wake the member WTRUs up. Following these member WTRUs' transition into the inactive or connected state, the anchor WTRU may be able to support the additional (e.g., the third) member WTRU in the idle state. In examples, the anchor WTRU may inform the additional member WTRU (e.g., the third member WTRU) that the anchor WTRU may not be able to support it in the idle state in a subsequent time period (e.g., the next few transmission cycles), and the anchor WTRU may send an indication to the network such that the network may store the RRC context of the third member WTRU in the idle state. In examples, the anchor WTRU may determine that, due to its inability to support the additional member WTRU in the idle state, that member WTRU should leave the WTRU group, and the anchor WTRU may send an indication to the member WTRU indicating the determination.

An anchor WTRU may not be able to go into an idle state while operating as a designated anchor WTRU for a WTRU group. The anchor WTRU may promote another member WTRU within the group to the role of an anchor WTRU or may transfer the context of the WTRU group to another anchor WTRU (e.g., in a surrounding area) before the designated anchor WTRU transitions into the idle state. A hierarchy of WTRUs (e.g., for taking the anchor role) may be defined within the WTRU group such that a newly designated anchor WTRU may take on the anchor role without degrading an XR experience. This hierarchy may be used, for example, if the current anchor WTRU experiences a link failure, and a fast and seamless take-over by a member WTRU may be desired.

An anchor WTRU may transition from a connected state to an inactive state while maintaining its role as a designated anchor WTRU. One or more conditions may be imposed for the anchor WTRU to have this behavior. For example, the anchor WTRU may transition to, operate in, or remain in the inactive state if one or more member WTRUs (e.g., all of the member WTRUs) of a WTRU group are in the idle state and the anchor WTRU knows (e.g., via an indication from an XR application) that none of the member WTRUs may perform a random access procedure during a time window (e.g., a pre-configured or pre-set time duration in the future). The anchor WTRU may transition into the inactive state during that time window. As another example, the anchor WTRU may transition to the inactive state in response to receiving an indication from an XR application regarding upcoming traffic characteristics associated with the XR application and/or upcoming traffic characteristics of one or more (e.g., all) member WTRUs in the WTRU group for a time window. The anchor WTRU may transition into the inactive state in response to determining that the anchor WTRU may no longer be involved with a request or coordination action during the aforementioned time window. As yet another example, the anchor WTRU may consider an expected traffic pattern or traffic characteristics over a sidelink interface with one or more (e.g., all) member WTRUs of the WTRU group before the anchor WTRU sends a request to the network to transition into the inactive state.

An anchor WTRU and/or member WTRU may be configured to implement one or more of the following in a fallback scenario. The anchor WTRU may send to the member WTRU (e.g., via an SL interface) information (e.g., parameters) that the member WTRU may use to start data transmission (e.g., such that the member WTRU may bypass a RACH procedure). Such information (e.g., parameters) may include, for example, a timing advance for synchronization, an SSB beam indication or measurement, an uplink grant, etc. The anchor WTRU may send to the network (e.g., a gNB) information that may be used to facilitate the data transmission by the member WTRU (e.g., without performing an initial access procedure). Such information may include, for example, a random access preamble sent by the anchor WTRU to the network on behalf of the member WTRU, an identifier of the member WTRU, location, positioning, and/or orientation information associated with the member WTRU, information on the size of a UL payload associated with the member WTRU, etc. In examples, the member WTRU may be configured to use the information sent by the anchor WTRU (e.g., via the SL interface) to transmit data in the UL, for example, without performing an initial access procedure. In examples, the member WTRU may be configured with conditions under which the member WTRU may bypass the initial access procedure (e.g., by allowing the anchor WTRU to perform the initial access procedure on behalf of the member WTRU) and/or resort to a fallback mechanism, with which the member WTRU may perform the initial access procedure on its own. These conditions (e.g., fallback conditions) may be configured on a per-WTRU basis for the member WTRU. The conditions (e.g., fallback conditions) may be based on one or more of the following.

The fallback conditions may be based on a co-location situation of the member WTRU. The member WTRU may be configured to resort to the fallback mechanism for the initial access procedure (e.g., perform initial access on its own without assistance from the anchor WTRU) if a co-location condition associated with the member WTRU and the anchor WTRU is not met. Whether the co-location condition is met may be determined based on one or more of the following. The co-location condition may be deemed not met if the member WTRU is not spatially close to the anchor WTRU, which may be determined based on whether the distance between the member WTRU and the anchor WTRU is smaller than a threshold configured by the network (e.g., a base station). The member WTRU may periodically measure its spatial or physical distance to the anchor WTRU (e.g., with a periodicity configured by the network). The member WTRU may measure its spatial or physical distance to the anchor WTRU in response to a request or trigger by the anchor WTRU to do so. The member WTRU may measure its spatial or physical distance to the anchor WTRU in response to a request or trigger by the network to do so. The member WTRU may measure its spatial or physical distance to the anchor WTRU in response to a change in the position, movement, or orientation of the member WTRU. The member WTRU may receive information from the anchor WTRU regarding the distance or a change in the distance between the anchor WTRU and the member WTRU. The member WTRU may receive information from the network regarding the distance or a change in the distance between the anchor WTRU and the member WTRU. The member WTRU may receive information from an XR application (e.g., which may reside in one or more WTRUs of a WTRU group, in the core network, in an edge server, in a RAN node, etc.) regarding the distance or a change in the distance between the anchor WTRU and the member WTRU.

The fallback conditions may be based on a UL grant size. For example, the member WTRU may be configured to resort to a fallback mechanism for an initial access (e.g., perform initial access on its own without assistance from the anchor WTRU) if the size of a UL grant forwarded, indicated, reserved, or granted by the anchor WTRU is not large enough to accommodate the UL data that the member WTRU may have for the network (e.g., the UL data in the member WTRU's buffer may be associated with PDU sets, frames, and/or data bursts, which may be large in size). The member WTRU may be configured with a threshold (e.g., by a base station) such that if the UL data in the WTRU's buffer is larger than the threshold, the member WTRU may resort to performing an individual initial access (e.g., without assistance from the anchor WTRU).

The fallback conditions may be based on the quality of service (QOS) (e.g., latency, data rate, SINR, etc.) of the member WTRU, the anchor WTRU, and/or the network. For example, the member WTRU may be configured to resort to a fallback mechanism for an initial access (e.g., perform initial access on its own without assistance from the anchor WTRU) if the member WTRU determines that it may not meet the QoS requirements for UL data using a UL grant forwarded, indicated, reserved, or granted by the anchor WTRU. The WTRU may determine that it may not be able to transmit a packet within the packet delay budget (PDB) associated with the packet, or transmit a PDU set within a PDU set delay budget (PSDB) associated with the PDU set by using the UL grant indicated by the base station. As such, the member WTRU may determine to perform the initial access procedure on its own.

The fallback conditions may be based on a reliability requirement. For example, the member WTRU may be configured to resort to a fallback mechanism for an initial access (e.g., perform initial access on its own without assistance from the anchor WTRU) if the member WTRU determines that it cannot send UL data in accordance with a reliability requirement using the UL grant secured by the anchor WTRU on behalf of the member WTRU.

The fallback conditions may be based on a measurement such as a channel measurement, an SSB measurement, and/or a positioning measurement. For example, the anchor WTRU may perform a channel measurement (e.g., a CSI measurement) on its Uu link and send a measurement report to the member WTRU regarding the channel measurements. The member WTRU may perform a channel measurement on its own Uu link. The member WTRU may be configured with a threshold on channel measurement parameters (e.g., PMI, CQI, etc.) such that if the difference between the channel measurement of the member WTRU and the channel measurement of the anchor WTRU differs by more than a preconfigured threshold, the member WTRU may resort to the fallback mechanism for the initial access procedure (e.g., perform initial access on its own without assistance from the anchor WTRU). The member WTRU may perform an SSB measurement (e.g., similar to the CSI-RS measurement in the previous example). If the SSB measurement performed by the member WTRU pertains to a different beam from an SSB measurement performed by the anchor WTRU, the member WTRU may resort to the fallback mechanism for the initial access (e.g., perform the initial access on its own without assistance from the anchor WTRU). The anchor WTRU may receive a reference signal (e.g., a positioning reference signal (PRS) from the network (e.g., base station) and perform a positioning measurement on the PRS. The anchor WTRU may share its positioning measurement with the member WTRU (e.g., via a sidelink interface). The network may share the positioning information of the anchor WTRU with the member WTRU. The member WTRU may receive a reference signal (e.g., a PRS) from the network and perform a positioning measurement. The member WTRU may be configured with a threshold (e.g., by the network) such that if the member WTRU's positioning measurement differs from that of the anchor WTRU by an amount greater than the configured threshold, the member WTRU may resort to the fallback mechanism for the initial access procedure (e.g., perform the initial access on its own without assistance from the anchor WTRU).

An individual or stand-alone WTRU (e.g., not associated with a WTRU group or an anchor WTRU) may perform a standalone initial access procedure such as a 2-step or 4-step RACH procedure. The WTRU may send a random access preamble for itself to a base station (e.g., based on a legacy RACH procedure). The WTRU may send an indication to the base station about the size of the data to be transmitted in the UL such that a UL grant sent by the base station to the WTRU (e.g., in a message associated with the RACH procedure such as in Msg 2, Msg B, or Msg 4) may be suitable (e.g., in size and/or timing) for the data that the WTRU wants to transmit in the UL. The WTRU may then use the UL grant to transmit the data to the base station (e.g., in a RACH message such as Msg 3, Msg A, or any other message associated with the random access procedure).

Although features and elements described above are described in particular combinations, each feature or element may be used alone without the other features and elements of the preferred embodiments, or in various combinations with or without other features and elements. Although the implementations described herein may consider 3GPP specific protocols, it is understood that the implementations described herein are not restricted to this scenario and may be applicable to other wireless systems. For example, although the solutions described herein consider LTE, LTE-A, New Radio (NR) or 5G specific protocols, it is understood that the solutions described herein are not restricted to this scenario and are applicable to other wireless systems as well.

The processes described above may be implemented in a computer program, software, and/or firmware incorporated in a computer-readable medium for execution by a computer and/or processor. Examples of computer-readable media include, but are not limited to, electronic signals (transmitted over wired and/or wireless connections) and/or computer-readable storage media. Examples of computer-readable storage media include, but are not limited to, a read only memory (ROM), a random access memory (RAM), a register, cache memory, semiconductor memory devices, magnetic media such as, but not limited to, internal hard disks and removable disks, magneto-optical media, and/or optical media such as compact disc (CD)-ROM disks, and/or digital versatile disks (DVDs). A processor in association with software may be used to implement a radio frequency transceiver for use in a WTRU, terminal, base station, RNC, and/or any host computer.

1. A wireless transmit/receive unit (WTRU), comprising:
a processor configured to:
transmit a first message to a network device, wherein the first message includes information regarding a group-based random access procedure associated with a group of WTRUs;
receive a response from the network device, wherein the response indicates one or more resources for the group-based random access procedure;
determine an allocation of the one or more resources to the group of WTRUs associated with the group-based random access procedure; and
send an indication to the group of WTRUs via one or more sidelink messages, wherein the indication indicates the allocation of the one or more resources to the group of WTRUs.

2. The WTRU of claim 1, wherein the processor is configured to determine the allocation of the one or more resources to the group of WTRUs autonomously.

3. The WTRU of claim 2, wherein the processor being configured to determine the allocation of the one or more resources to the group of WTRUs comprises the processor being configured to determine that the one or more resources are insufficient to accommodate the group of WTRUs for the group-based random access procedure.

4. The WTRU of claim 3, wherein the processor is configured to allocate the one or more resources to the group of WTRUs based on respective transmission priorities associated with the group of WTRUs.

5. The WTRU of claim 3, wherein the processor is configured to allocate the one or more resources to the group of WTRUs based on respective transmission time constraints associated with the group of WTRUs.

6. The WTRU of claim 1, wherein the one or more resources are associated with a contention-free access to the network device by the group of WTRUs.

7. The WTRU of claim 1, wherein the response received from the network device includes information that indicates how the one or more resources are to be allocated to the group of WTRUs, and wherein the processor is configured to determine the allocation of the one or more resources to the group of WTRUs based on the information included in the response.

8. The WTRU of claim 1, wherein the first message includes a random access preamble associated with the group-based random access procedure and indicates a number of WTRUs associated with the group-based random access procedure.

9. The WTRU of claim 1, wherein the processor is further configured to identify the group of WTRUs associated with the group-based random access procedure based on sidelink communications between the WTRU and the group of WTRUs.

10. The WTRU of claim 1, wherein the WTRU is configured to operate as an anchor for the group of WTRUs.

11. The WTRU of claim 1, wherein the processor is further configured to transmit a second message to the network device, the second message indicating the allocation of the one or more resources to the group of WTRUs.

12. The WTRU of claim 1, wherein the one or more resources indicated by the response received from the network device are for performing the group-based random access procedure over an interface between the network device and the group of WTRUs.

13. A method implemented by a wireless transmit/receive unit (WTRU), the method comprising:
transmitting a first message to a network device, wherein the first message includes information regarding a group-based random access procedure associated with a group of WTRUs;
receiving a response from the network device, wherein the response indicates one or more resources for the group-based random access procedure;
determining an allocation of the one or more resources to the group of WTRUs associated with the group-based random access procedure; and
sending an indication to the group of WTRUs via one or more sidelink messages, wherein the indication indicates the allocation of the one or more resources to the group of WTRUs.

14. The method of claim 13, wherein the allocation of the one or more resources to the group of WTRUs is determined by the WTRU autonomously based on respective transmission priorities or transmission time constraints associated with the group of WTRUs.

15. The method of claim 13, wherein the one or more resources are associated with a contention-free access to the network device by the group of WTRUs.

16. The method of claim 13, wherein the response received from the network device includes information that indicates how the one or more resources are to be allocated to the group of WTRUs and wherein the allocation of the one or more resources to the group of WTRUs is determined based on the information included in the response.

17. The method of claim 13, further comprising identifying the group of WTRUs associated with the group-based random access procedure based on sidelink communications between the WTRU and the group of WTRUs.

18. The method of claim 13, wherein the one or more resources indicated by the response received from the network device are for performing the group-based random access procedure over an interface between the network device and the group of WTRUs.

19-21. (canceled)

22. The method of claim 13, further comprising transmitting a second message to the network device, wherein the second message indicates the allocation of the one or more resources to the group of WTRUs.

23. The method of claim 13, wherein the WTRU is configured to operate as an anchor for the group of WTRUs.
